(19) United States
(12) Patent Application Publication
(10) Pub. No.: US 2015/0121523 A1
(43) Pub. Date: Apr. 30, 2015

(54) SYSTEMS AND METHODS FOR FACILITATING REMOTE SECURITY THREAT DETECTION

(71) Applicant: MSA Security, Inc., New York, NY (US)

(72) Inventors: Raymond Crowley, North Haven, CT (US); Brian Roberds, Broken Arrow, OK (US); Daniel Krantz, Flemington, NJ (US); Timothy Surface, Raleigh, NC (US); Shawn Wood, Stewartsville, NJ (US)

(21) Appl. No.: 14/064,100

(22) Filed: Oct. 25, 2013

(51) Int. Cl. H04L 29/06

(52) U.S. Cl. CPC H04L 63/1441
USPC 726/23

(57) ABSTRACT

Systems and methods are disclosed for detecting security threats in a network environment. A local workstation is used to inspect an item and submit a request for assistance to determine whether the item raises a security threat. A server receives the request for assistance from the local workstation over a network, selects a remote expert device that is available to receive the request and routes the request to the remote expert device. In response to the request being accepted at the remote expert device, the server may transmit information associated with the local workstation to the remote expert device and establish a connection between the local workstation and the remote expert device. The remote expert device utilizes attribute information pertaining to the local workstation or local operator to facilitate effective communications between the local workstation and remote expert device for determining whether the item raises a security threat.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present principles are directed to systems and methods for detecting security threats, and more particularly, to improving the detection of such threats in a network environment by intelligently connecting and facilitating communication between a screening operator and a remote expert in order to efficiently evaluate a potential security threat.

### BACKGROUND OF THE INVENTION

The importance of detecting potential security threats has dramatically increased in recent years. Airports, seaports, mailrooms and border checkpoints (e.g., U.S. Customs and Border Protection locations) handle countless packages, shipments and baggage items on a daily basis, some of which may include dangerous articles. Concert venues, sports stadiums and other highly populated locations or high risk environments pose particular concerns given the extensive harm that may be inflicted in the event that a security threat goes undetected. To interject such threats, many locations utilize screening equipment to scan items (e.g., cargo, bags, luggage, mail or shipment containers) for the purpose of detecting explosives, weapons, contraband or other materials that may pose a security risk. The screening equipment (e.g., x-ray machines) is operated by security personnel who may need to be in contact with subject matter experts (e.g., a bomb detection expert) to analyze the items which are being scanned.

In one useful configuration for a threat detection system, individuals who operate and monitor screening devices at the screening locations are placed in communication with experts who are located remotely. Often times, the screening device operators are able to determine whether or not a large majority of items pose a security threat. However, if a screening device operator is unable to determine whether a particular item presents a security threat, the operator may contact the remotely located expert for assistance in evaluating the item. This particular configuration is practical because the number of potential security threats is relatively low in comparison to the total number of items being scanned. Thus, experts need not be located at, dispatched or dedicated to, each and every screening site, giving them the ability to assist multiple sites remotely. Accordingly, a relatively small number of experts can be utilized to assess potential security threats at various screening locations that deploy large numbers of screening devices.

Although the configuration of the threat detection system described above has many advantages, effectively implementing such a system can be difficult for several reasons. First, the fact that the experts are located remotely from the individuals who are operating the screening devices can create a time delay, with respect to both establishing a connection with the expert and assessing whether a suspicious item poses a security threat. Given the volume of items that need to be evaluated and the safety concerns that are presented by a potential security threat, it is important to minimize the time spent establishing such connections between operators and remote experts, as well as the time required to assess the potential security threat.

For example, in the case that a screening device operator is unsure whether a package or bag includes an explosive device, the screening device operator should be able to immediately connect to an expert who can assist with the evaluation the item. Once connected, it is also important that the screening device operator and expert be provided with suitable communication features and tools to enable the screening device operator and expert to collaborate, assess the potential security threat, and implement any necessary safety precautions. For example, the remote expert should be able to view one or more images produced by the screening device, interact with the operator (e.g., answer questions or ask the operator to manipulate the item to produce additional views) and communicate a final determination all in real-time. Any time delays may not only frustrate the ability to process increasingly growing number of items, but can even cause interruptions for the individuals whose items are being inspected, as well as the buildup of long lines in high-volume or highly populated screening locations (e.g., mailrooms, security checkpoints at an airport, stadium or other venue). Thus, a need exists for providing a threat detection system that is able to quickly establish connections between screening device operators and remote experts, and which further provides the communication features and tools for assessing potential security threats in an expedited and efficient manner.

Another obstacle presented by the threat detection system described above relates to language barriers that may exist between screening device operators and remote experts. Not only do such barriers slow down the process, they can lead to a total breakdown of communication when the screening device operator and remote expert cannot understand each other. Thus, a need exists for providing a threat detection system that permits a potential security threat to be quickly resolved in the case that a screening device operator and remote expert do not speak the same language.

Similarly, other obstacles associated with the threat detection system described above relate to ensuring that communications between the screening device operator and remote expert are clear and unambiguous. Given the seriousness of a potential security threat, it is important for the screening device operator to understand the questions or messages that are being conveyed by a remote expert, and vice versa. Failure to understand one another may be the result of a language barrier as described above, or may be due to other factors such as technical problems associated with the connection between the two parties (e.g., situations in which voice communications are impaired) or physical disabilities associated with one or more of the parties. Regardless of what causes the breakdown in communication, the result could be disastrous if a message is missed or misunderstood (e.g., if a screening device operator clears an item which was deemed to be a true security threat by the remote expert). Thus, a need exists for providing a threat detection system that is able to unambiguously convey messages between screening device operators and remote experts, and which provides a redundant means for communicating the messages.

### SUMMARY OF THE INVENTION

Several embodiments for a threat detection system are disclosed that overcome some or all of the obstacles and problems described above as well as other obstacles and problems associated with detecting security threats in a network environment. One aspect of the invention is to provide a threat detection system that enables local operators to submit requests to one or more remotely located experts for assistance in resolving a potential security threat. Another aspect of the invention is to provide a threat detection system that quickly establishes a connection between local operators and remote experts and allows them to communicate and interact in real-time. Yet another aspect of the invention is to provide a threat detection system that permits local operators and remote experts to communicate using unambiguous and redundant forms of communication. An even further aspect of the invention is provide a threat detection system that overcomes language barriers that may exist between local operators and a remote experts.

In accordance with certain embodiments of the present invention, a system is disclosed for detecting security threats in a network environment. The system comprises a local workstation, a remote expert device and a server. The local workstation may be configured to render scanning data generated by a screening device associated with an item being inspected and submit a request for assistance to determine whether the item raises a security threat. The remote expert device may be configured to accept the request for assistance submitted by the local workstation and receive attribute information associated with the local workstation and an individual operating the local workstation. The attribute information may be utilized to facilitate communications between the local workstation and the remote expert device. The remote expert device may utilize the attribute information to communicate with the local workstation for determining whether the item relates to a security threat. The attribute information may be stored on the server. The server may be further configured to receive the request for assistance from the local workstation over a network, determine that the remote expert device is designated as active and route the request to the remote expert device. In response to the request being accepted by the remote expert device, the server may transmit the attribute information to the remote expert device and establish a connection between the local workstation and the remote expert device.

In accordance with the certain embodiments of the present invention, a server is disclosed for detecting security threats in a network environment. The server maintains a list of local workstations and remote expert devices that are registered with a threat detection system and stores attribute information associated with the local workstations and individuals operating the local workstations. The attribute information may be utilized to facilitate communications between the local workstations and the remote expert devices in the list. The server is further configured to receive a request over a network from a first local workstation for assistance in determining whether an item presents a security threat. In response to receiving the request, the server may identify the remote expert devices in the list that are designated as active and select one or more of the identified remote expert devices to receive the request from the first local workstation. The server may route the request to the one or more selected remote expert devices. In response to the request being accepted by the one or more selected remote expert devices, the server may transmit the attribute information associated with the first local workstation to the one or more selected remote expert devices and establish a connection between the first local workstation and the one or more selected remote expert devices.

In accordance with certain embodiments, attribute information stored in a database on a server may be utilized to efficiently route a request and reduce the time delay associated with assessing a potential security threat. The attribute information may indicate traits, characteristics, and other information about the local operators, local workstations, remote experts, remote expert devices and/or the screening devices. Upon receiving or accepting a request, some or all of the attribute information may be displayed to a remote expert and local operator handling a request. The attribute information may specify a language preference for a local operator and a remote expert. Communications between a local workstation and a remote expert device may be customized based on the language preference information. In certain embodiments, the local workstation and remote expert device may communicate using pictograms. The content of the pictograms may be selected based on the language preference information. The pictograms may convey an unambiguous message utilizing both graphics and text. The clarity and redundancy provided by the pictograms assists with expediting an evaluation of potential security threats and provides a higher level of certainty that appropriate actions will be taken to handle potential security threats.

These and other features and advantages will become apparent from the following detailed description of illustrative embodiments thereof, which is to be read in connection with the accompanying drawings.

### BRIEF DESCRIPTION OF DRAWINGS

The inventive principles are illustrated in the figures of the accompanying drawings which are meant to be exemplary and not limiting, in which like references are intended to refer to like or corresponding parts, and in which:

FIG. 1 is a block diagram illustrating a threat detection system in accordance with certain embodiments of the present invention.

FIG. 2 is a block diagram illustrating a detailed view of a threat detection server in accordance with certain embodiments of the present invention.

FIG. 3A illustrates an exemplary startup interface that may be displayed on a local workstation in accordance with certain embodiments of the present invention.

FIG. 3B illustrates an exemplary interface that may be displayed on a local workstation for submitting requests for assistance to a remote expert in accordance with certain embodiments of the present invention.

FIG. 3C illustrates an exemplary interface that may be displayed on a local workstation in response to receiving an alert message from a remote expert in accordance with certain embodiments of the present invention.

FIG. 3D illustrates an exemplary interface that may be displayed on a local workstation in response to receiving a pictogram from a remote expert in accordance with certain embodiments of the present invention.

FIG. 3E illustrates an exemplary interface that may be displayed on a local workstation in response to receiving a text message from a remote expert in accordance with certain embodiments of the present invention.

FIG. 3F illustrates an exemplary management interface that may be displayed on a remote expert device in accordance with certain embodiments of the present invention.

FIG. 3G illustrates an exemplary interface that may be displayed on a remote expert device while a request for assistance from a local operator is being handled in accordance with certain embodiments of the present invention.

FIG. 3H illustrates an exemplary interface that may be displayed on a remote expert device for transmitting a pictogram to a local workstation in accordance with certain embodiments of the present invention.

FIG. 3I illustrates an exemplary interface that may be displayed on a remote expert device for capturing and manipulating images while handling a request for assistance from a local operator in accordance with certain embodiments of the present invention.

FIG. 3J illustrates an exemplary interface that may be displayed on a remote expert device when terminating a session with a local operator in accordance with certain embodiments of the present invention.

FIG. 4 is a flow chart of a method for establishing a connection between a local workstation and a remote expert device in accordance with certain embodiments of the present invention.

FIG. 5 is a flow chart of a method for transmitting a pictogram to a local workstation in accordance with certain embodiments of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

A threat detection system is disclosed for analyzing and detecting security threats at one or more screening locations (e.g., airports, seaports, Customs checkpoints, mailrooms, security checkpoints, stadiums and other venues or high-risk environments). Screening devices at the screening locations may be utilized to analyze and inspect items (e.g., cargo, bags, packages, luggage, mail, shipment containers or other items) to determine whether an item is or contains a security threat. Similarly, the screening devices may also be utilized to analyze or inspect individuals to determine whether the individuals include items that present a security threat. In certain embodiments, the screening devices may include X-ray scanning equipment, whole body imaging (WBI) equipment, computed tomography (CT) scanning equipment and/or other types of imaging equipment. The screening devices may be utilized to detect security threats including, but not limited to, explosives, weapons, contraband and narcotics.

To assist in detecting security threats, the screening devices may analyze items and generate scanning data for display on a local workstation (e.g., desktop computer, laptop computer, tablet, mobile device or other type of computing device) at a screening location. The scanning data displayed on the local workstation may include X-ray images and/or other types of imaging data generated by the screening devices. In some cases, the scanning data may also include a real-time video feed comprising imaging data generated by the screening devices. Local operators at the screening location may inspect the scanning data displayed on the local workstations to determine whether items pose a security threat.

The local workstations situated at the screening location may be in communication with one or more servers over a network (e.g., such as network that includes the Internet, a local area network, a wide area network, an intranet, a virtual private network or other network). The local operator may submit a request to the server to establish a connection with a remotely located expert. A plurality of different requests may be sent. A first type of request may be a threat assessment request for requesting assistance of a remote expert in determining whether an item poses a security threat. A second type of request may be a diagnostics request for requesting assistance from a remote expert for resolving technical problems. A third type of request may be a testing or calibration request for testing the connectivity of a device being utilized by the local operator and/or for ensuring that screening devices and other equipment are properly calibrated. Other types of requests may also be transmitted.

Requests submitted by the local operator may be transmitted over a network to a server. Upon receiving a request, the server establishes a connection between the local workstation and a device utilized by a remote expert. Advantageously, the server establishes the connection in an expedited manner by selecting remote experts to receive the request who have a high probability of accepting the request. In certain embodiments, the server may select a remote expert to receive a request by identifying a subset of registered expert devices that are designated as active, and thereafter identifying the expert device in the subset that is queued to receive the next request. In certain embodiments, the expert device that is queued to receive the next request may be an active, expert device for which the longest period of time has elapsed since the device received a request, accepted a request or concluded a request. The server may establish a connection between the selected expert device and the local workstation when a remote expert accepts the request. Otherwise, if the remote expert fails to accept the request, the server may designate the remote expert device as idle, thus preventing the remote expert device from receiving requests until a point in time when the device provides an explicit indication to the server that it is available to accept requests. In certain embodiments, the server also utilizes a language preference of the local operator and/or a priority value associated with the type of request to select a remote expert device for receiving a request.

The connection between the local operator and remote expert permits the local operator to communicate with the remote expert using voice, text and data communications. In certain embodiments, the connection may permit the local operator and remote expert to communicate with each other utilizing pictograms. Each pictogram is associated with a particular message and may include text, icons, images, video and/or other multimedia data for conveying a message. The content of a selected pictogram may vary based on the language of the recipient that is intended to receive the message. The sender of a pictogram may select a pictogram to convey a particular message to a recipient of the message and the server may automatically select content to populate the pictogram based on the language of the recipient. In addition to overcoming language barriers that may exist between a local operator and a remote expert, the pictograms serve a useful role in providing a redundant form of communicating messages that helps to ensure that messages are unambiguously conveyed to recipients.

Audit data is stored on the server for each request that is submitted by a local operator. The audit data includes information about the local operator, local workstation and screening device associated with the source of the request, as well as any remote expert and remote expert device that received the request, accepted the request or assisted with handling the request. The audit data may further include scanning data (e.g., images or video) that was generated in analyzing the item that was the subject of a request, as well as any communications (e.g., via voice, text or pictograms) that took place between the local operator and the remote expert associated with the request. The audit data may be utilized to generate reports, circulate alerts, evaluate the performance of individuals (e.g., local operators and remote experts), and for training purposes.

Embodiments described herein may be hardware-based, software-based and preferably comprise a mixture of both hardware and software elements. Thus, while the description herein may describe certain embodiments, features or components as being implemented in software or hardware, it should be recognized that any embodiment, feature or component that is described in the figures or description of the present application may be implemented in hardware and/or software. In certain embodiments, particular aspects are implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates or transports the program for use by or in connection with the instruction execution system, apparatus or device. The medium can be magnetic, optical, electronic, electromagnetic, infrared or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

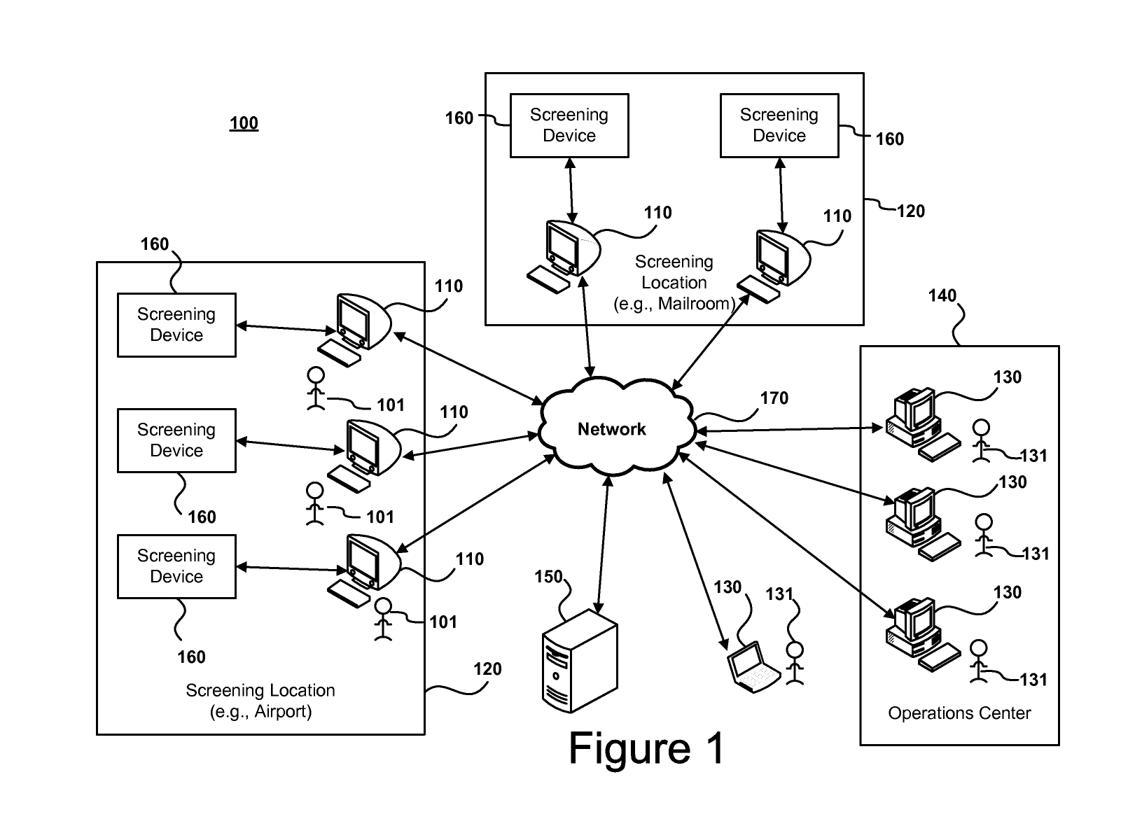

Referring now to the drawings in which like numerals represent the same or similar elements and initially to FIG. 1, a threat detection system 100 is disclosed for detecting security threats. A plurality of screening locations 120 are connected to, and in communication with, a remotely located operations center 140 via a network 170. More specifically, local operators 101 situated at the screening locations 120 may utilize local workstations 110 to communicate with one or more remote expert devices 130 to obtain assistance from remote experts 131 in assessing potential security threats at the screening locations 120. In certain embodiments, a server 150 may be utilized to establish a connection between the local workstations 110 and the remote expert devices 130, as well as to perform other types of useful functions related to assessing a security threat.

The network 170 may be any type of network such as one that includes the Internet, a local area network, an intranet, a virtual private network, a wide area network, etc. In certain embodiments, the local workstations 110, remote expert devices 130 and/or the server 150 may be configured to communicate via wired or wireless links, or a combination of the two. In certain embodiments, the local workstations 110, remote expert devices 130 and/or the server 150 may be coupled to the network 170 via a local area network.

The local workstations 110 and remote expert devices 130 may represent a desktop computer, laptop, cell phone, tablet device, personal digital assistant or other type of computing device including a dedicated processor. The local workstations 110 and remote expert devices 130 may be equipped with one or more storage devices (e.g., RAM, ROM, PROM, SRAM, etc.) and one or more processing devices (e.g., a central processing unit) that are capable of executing computer program instructions. The storage device is preferably a physical, non-transitory medium. The local workstations 110 and remote expert devices 130 may further include a display that is capable of rendering an interface and one or more input devices (e.g., keyboard, microphone, camera, video camera, scanner, joystick, remote control device, etc.). Local operators 101 and remote experts 131 may manipulate interfaces using the input devices and provide other types of input to communicate with each other.

The server 150 may also include one or more processors and one or more storage devices. The storage device is preferably a physical, non-transitory medium. The server 150 may generally represent any type of computing device that is capable of communicating with the local workstations 110 and remote expert devices 130. In certain embodiments, the server 150 comprises one or more mainframe computing devices. The storage medium on the server can store applications or software code that is configured to provide assistance to local operators 101 and remote experts 131 in performing tasks related to evaluating and resolving security threats. Specifically, the server 150 may be configured to establish a connection between the local workstations 110 and remote expert devices 130 and to track data related to requests that have been submitted by local operators 101. The server 150 may store any data that is related to, or associated with, the local workstations 110, remote expert devices 130, local operators 101, remote experts 131 and requests that have been submitted by local operators 101.

The screening location 120 may represent any location where items (e.g., luggage, bags, packages or mail) are screened such as an airport, mailroom, court house, stadium, security checkpoint or other location. Each screening location 120 may include one or more screening devices 160 that are configured to analyze or scan the items. Generally speaking, the screening devices 160 may represent devices which are capable of detecting security threats or risks including, but not limited to, devices which are capable of detecting explosives, weapons, contraband, narcotics, chemical hazards, or biological hazards. Exemplary screening devices 160 may include X-ray scanning equipment (e.g., the Smith 60-40 DS, Smith 50-30 DS or Morpho XRD 3500), whole body imaging (WBI) equipment (e.g., L-3 ProVision or RapiScan Secure 1000), CT scanning equipment and other types of imaging equipment.

During or immediately after the screening of an item, a screening device 160 generates scanning data (e.g., which may include one or more images or videos) as a result of the scanning or analysis of an item and provides this information to one or more local workstations 110. The local workstations 110 include software that is able to extract, process, manipulate and render the scanning data on the display of the local workstations 110. For example, the screen devices 160 may generate X-ray images and the software may include a set of image manipulation tools that permit a local operator 101 to rotate the images, zoom in/out on portions of the images, render the images in black and white, render the images in color or provide other types of image manipulation functions.

In certain embodiments, the screening devices 160 generate images of the items being scanned and the colors are assigned to portions of the images based on the density of the items in the image. The software on the local workstations 110 may display a warning or set off an alarm in response to detecting an item having a particular density. For example, if an item being scanned has the same or similar density as a C4 explosive, or other item that poses a security threat, the software may alert the local operator 101.

The local operator 101 may analyze the scanning data, possibly with the assistance of the manipulation tools, to determine whether an item being scanned is a security threat. If a local operator 101 is unable to determine whether an item is a security threat (or otherwise desires the assistance of a remote expert 131 for other reasons), the local operator 101 may transmit a request for assistance to a remote expert 131. In certain embodiments, the local operator 101 may request assistance of a remote expert 101 by selecting a connection button on an interface that is displayed on the local workstation 110 (e.g., by clicking on the button with a mouse or selecting the button with a gesture on a touch screen interface).

In certain embodiments, the local operator 101 may be able to submit three different types of requests to a remote expert 131. The first type of request is a threat assessment request which requests the assistance of a remote expert 131 in evaluating a potential security threat. The second type of request is a test and calibration request which can be utilized to confirm that a connection between a local workstation 110 and screening device 160 is able to be established. The third type of request is a diagnostics request which requests the assistance of a remote expert 131 (or technical expert) for troubleshooting or resolving technical difficulties associated with the local workstation 110 and/or screening device 160. The request may be encrypted, along with any other communications that take place among the remote expert 131, local workstation 110 and/or server 150.

In certain embodiments, each type of request may be assigned a priority indicator that identifies the importance of the request and that may be used to determine an order in which requests are routed to remote experts 131. In certain embodiments, threat assessment requests may be assigned the highest priority, diagnostics requests may be assigned the second highest priority, and test and calibration requests may be assigned the lowest priority. Thus, if a threat assessment request, diagnostics request and test and calibration request are submitted simultaneously by different local operators 101, the threat assessment request will be handled before the other requests since the threat assessment request is given the highest priority.

In certain embodiments, different types of threat assessment requests may be submitted and each may be assigned its own priority. For example, threat assessment requests may be assigned a priority ranking based on the location where the request originated or if a local operator 101 indicates that the request is a high priority.

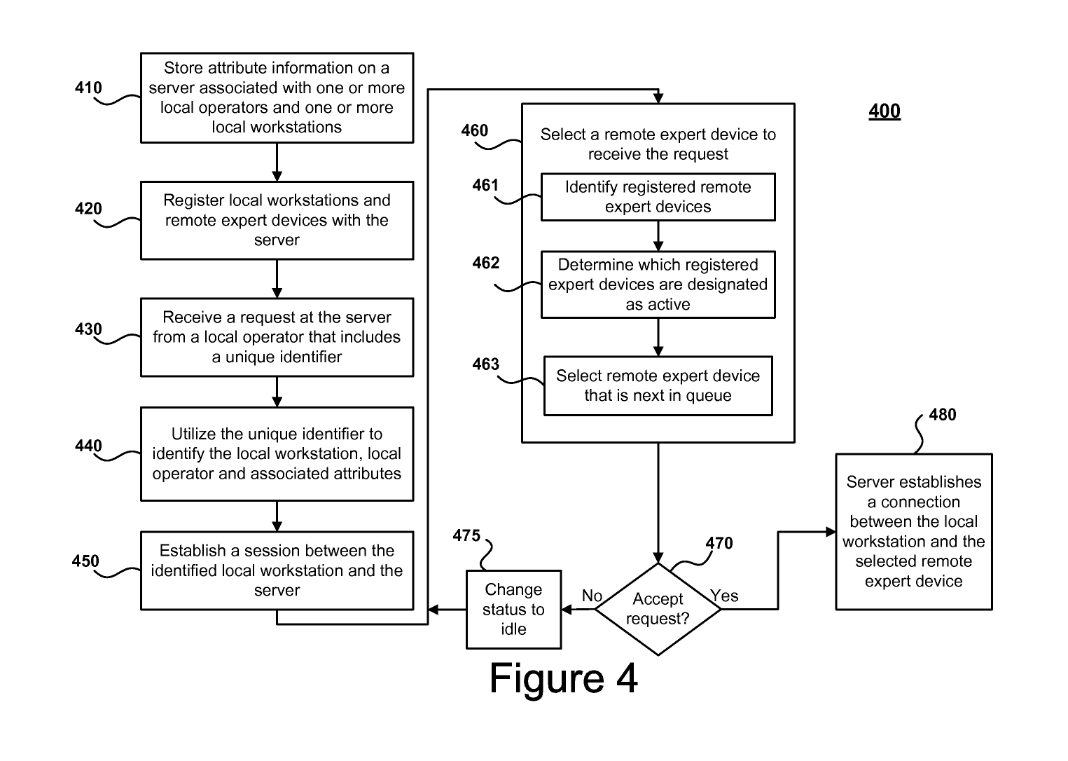

In certain embodiments, the request submitted by the local workstation 110 is transmitted to the server 150. The server 150 maintains a list of all local workstations and remote expert devices that are connected to and registered with the system. In response to receiving the request 150, the server 150 attempts to establish a connection with a remote expert device 130 that has registered with the server 150. In certain embodiments, this may include determining the status of the remote expert devices 130 that have registered with the server 150 and selecting a remote expert device 130 to handle the request. Additional details regarding the manner in which connections can be established between local workstations 110 and remote expert devices 130 is discussed in further detail below with reference to FIG. 4.

In certain embodiments, the connection between the local workstation 110 and the remote expert device 130 provides multiple communication channels. For example, the connection may establish separate communication channels for communicating voice, text (e.g., text provided by an instant messaging feature) and data between the local workstation 110 and the remote expert device 130. In certain embodiments, a live audio/video feed may also be utilized. The connection may be utilized to transmit X-rays images (and other scanning data) of items that pose a potential security threat to the remote expert device 130 in order to permit the remote operator 131 to review and evaluate the item. Any or all of the communication channels may be encrypted for security purposes.

The remote experts 131 may or may not be located at the operations center 140. The software on the remote expert devices 130 may permit a remote expert 131 to view the images or other scanning data that is displayed on the screen of the local expert devices 110. As a local operator 101 analyzes and manipulates the scanning data on a local workstation 110, this can be viewed in real-time by the remote expert 131 on the display of the remote expert device 130. The software on the remote expert devices 130 also provides the remote experts 131 with the manipulation tools for analyzing the scanning data.

In certain embodiments, the remote experts 131 can also be provided with remote access to the local workstations 110 to enable the remote experts 131 to remotely control the local workstations 110. The remote experts 131 may utilize the remote access connection in order to assess the item being scanned, to monitor the performance of a local operator 101, to assist with troubleshooting and technical issues, or to perform diagnostic functions associated with the local workstations 110 and/or screening devices 160.

After a remote expert 131 has finished evaluating an item, the remote expert 131 can communicate the results of the evaluation to the local workstation 110. The communication tools (e.g., voice, text and ability to view images as they are scanned) provided by the system enable the remote expert to interact in real-time with the local operator 101. For example, the remote expert 131 may indicate the conclusion reached by the remote expert 131 regarding whether or not an item is a true security threat or may indicate that it is unclear whether an item is a true security threat. The remote expert 131 may further instruct the local operator 101 to manipulate the item (e.g., to rotate or flip the item and re-scan the item). The remote expert 131 may also provide instructions to the local operator 101 for handling a potential or actual security threat. For example, the instructions may indicate that the screening location 120 should be evacuated, the item should not be touched or moved, the person who possessed the item should be questioned or that the item does not pose a security threat.

The manner in which the remote expert 131 communicates with the local operator 101 may vary. The connection established between the local operator 101 and the remote expert 131 may provide voice communications, thus permitting the parties to speak to one another. The local operator 101 and remote expert 131 may also utilize an instant messaging application or other messaging feature to communicate. As explained in further detail below, the local operator 101 and remote expert 131 may also utilize pictograms to unambiguously convey messages to one another. The pictograms may represent an image or overlay element that includes icons, images, text and/or other multimedia data for conveying a particular message (e.g., messages indicating that a local operator should rotate or flip an item being inspected by a screening device, a problem exists with an audio or video connection, or an item poses a security threat). Rather than creating a custom message each time a particular situation arises (e.g., each time the remote expert 131 determines that an item is not a security threat), a pictogram may be selected for communicating the message.

It should be noted that the system in FIG. 1 is merely meant to demonstrate an embodiment of an operating environment that can be utilized in conjunction with the invention taught herein, and should not be construed as limiting in any manner whatsoever. The particular configuration in FIG. 1 can be altered in numerous ways without departing from the principles herein. For example, it should be noted that the functionality of the server 150 in FIG. 1 may represent a plurality of servers 150. Likewise, any number of screening locations 120, local workstations 110, remote expert devices 130 and operations centers 140 may be utilized with the system 100 and the system may be configured in a variety of different ways (e.g., in a distributed computing environment, cloud-based environment, client-server environment, etc.).

Furthermore, it should be recognized that the functionality provided by the server 150 may be performed locally by the workstations 110, remote expert devices 130, or a combination of the two. Thus, any processes or procedures performed by the server 150 can alternatively be implemented by the workstations 110 and/or remote expert devices 130, and vice versa.

In addition, while the disclosure herein refers to a threat detection system 100 which scans items to detect potential security threats, it should be understood that the term “items” is also meant to encompass individuals. Thus, any disclosure herein which relates to scanning items should also be understood to encompass the scanning of individuals (e.g., using WBI equipment). Furthermore, while the disclosure herein describes experts 131 as being “remote” or “remotely located,” it should be understood that this does not necessarily require the experts 131 to be located at a location which is separate from the screening location 120, but is merely meant to imply that the experts 131 are not located in the immediate vicinity of the screening device 160 or local operator 101. For example, in certain embodiments, the remote experts 131 and operations center 140 may be located in a security room at a screening location 120.

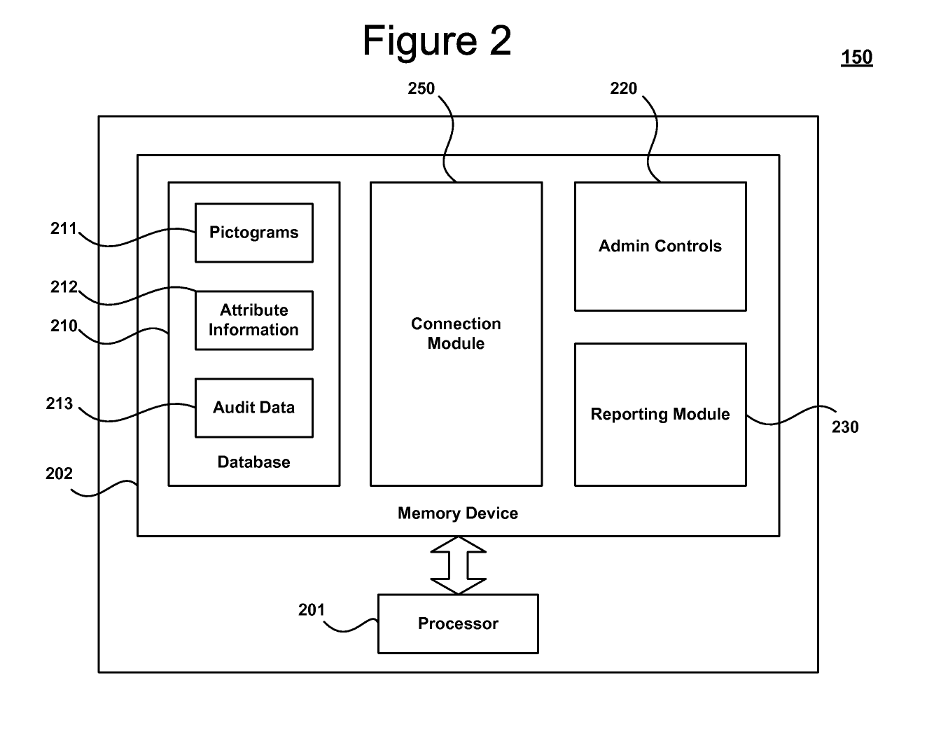

Moving on to FIG. 2, a detailed view of the server 150 is disclosed in accordance with certain embodiments of the present invention. As shown therein, the server 150 includes a plurality of software components (e.g., connection module 250, admin controls 220, etc.) stored on a memory device 202 (e.g., RAM, ROM, PROM, SRAM, etc.). The memory device 202 is in communication with one or more processors 201 that may be configured to execute the instructions associated with software components.

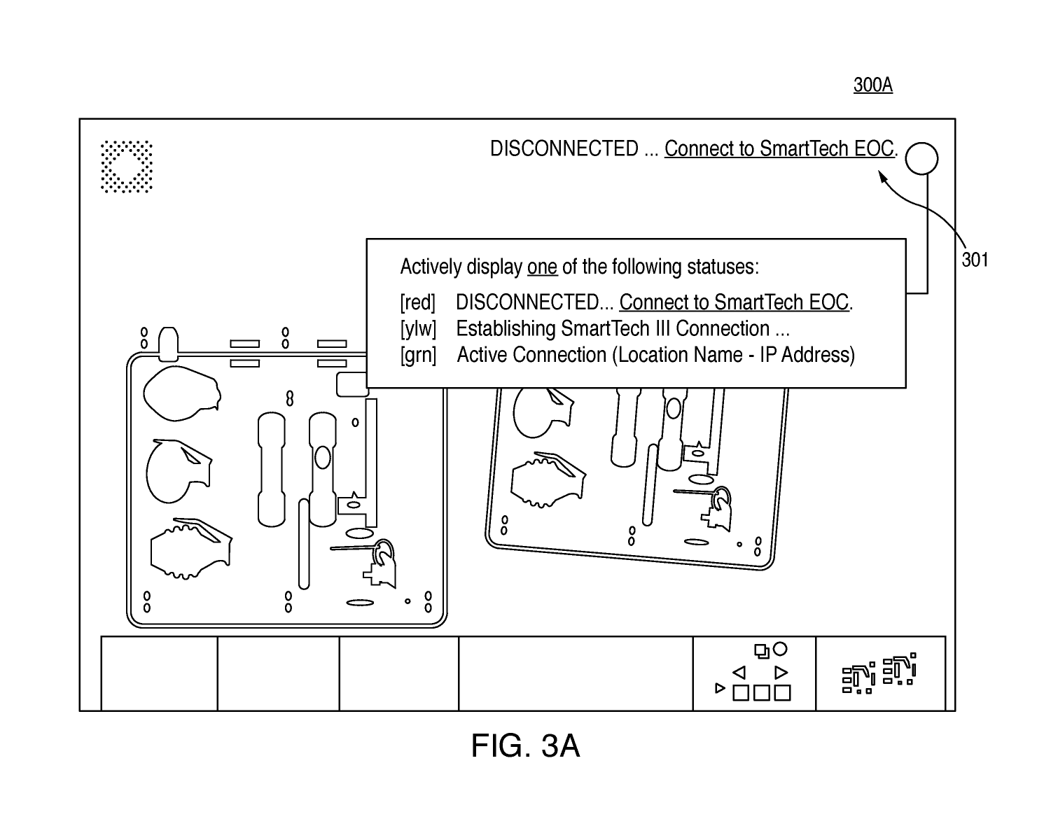

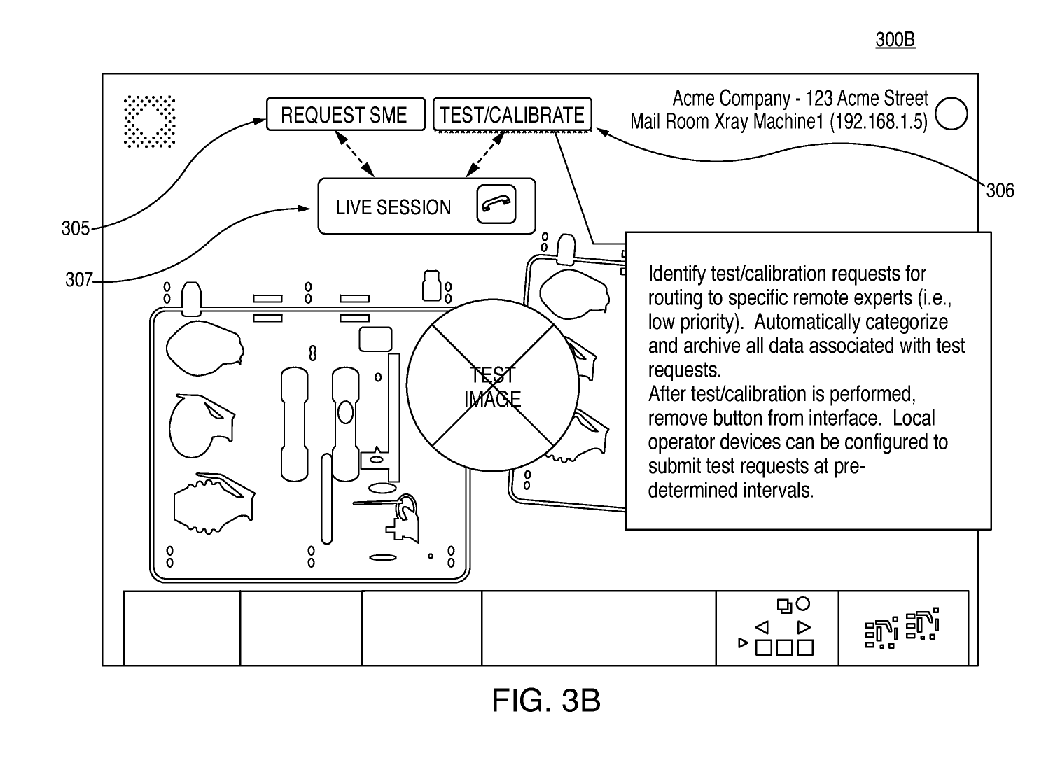

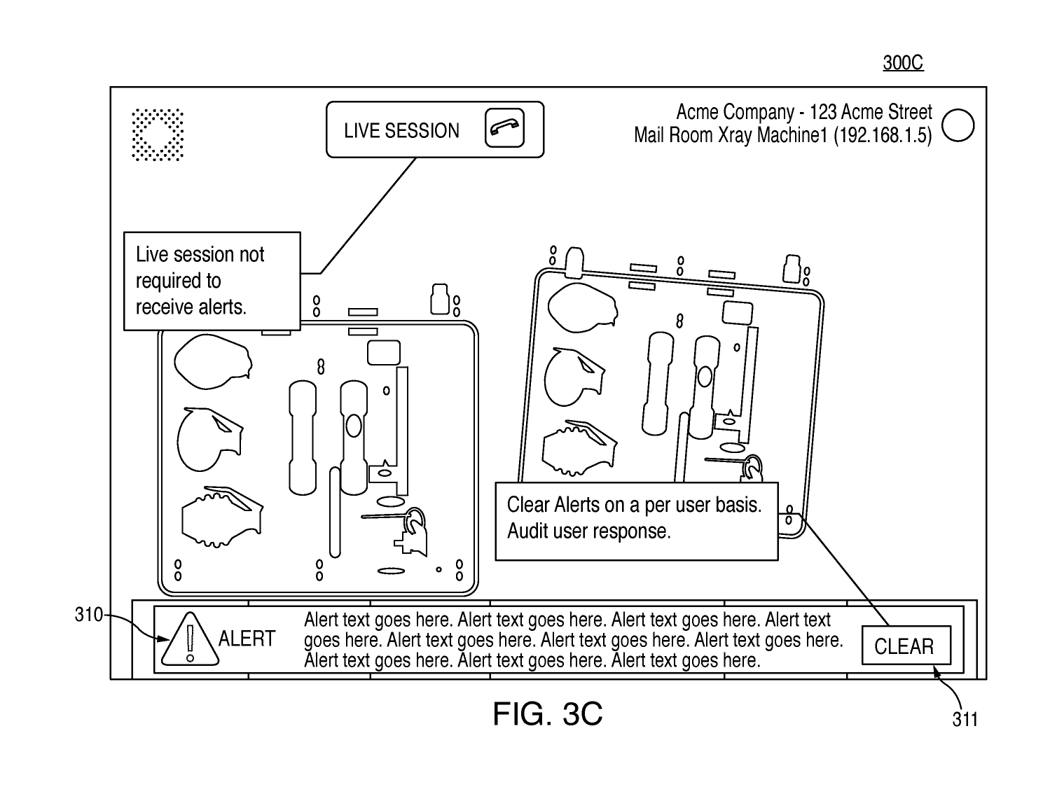

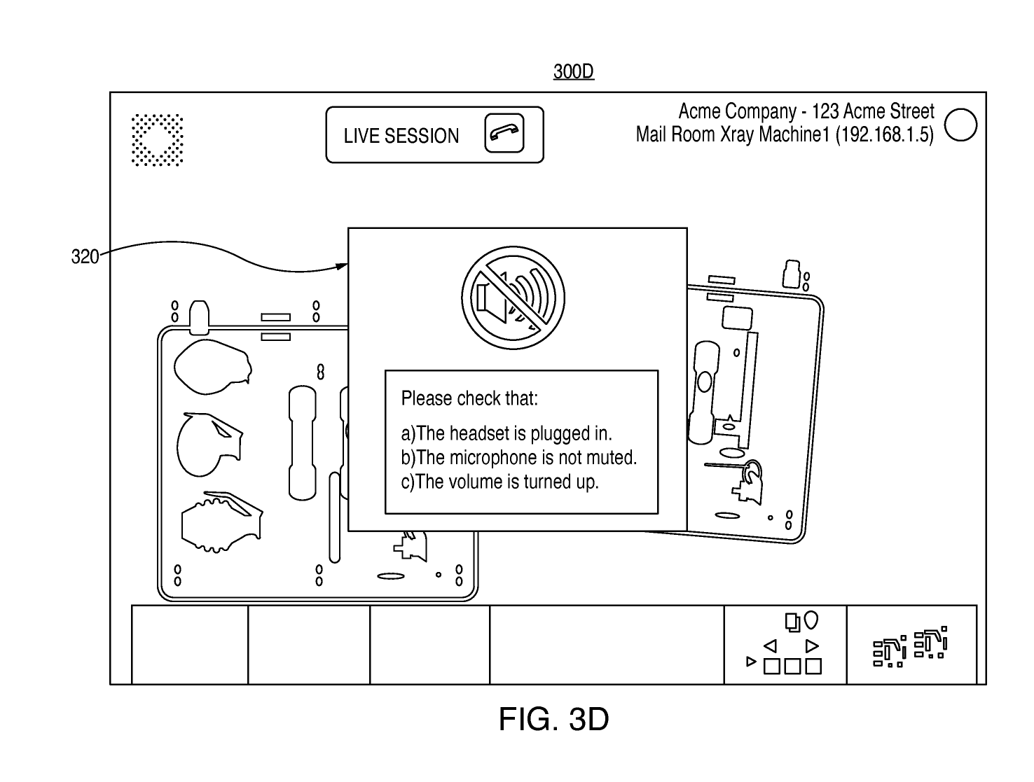

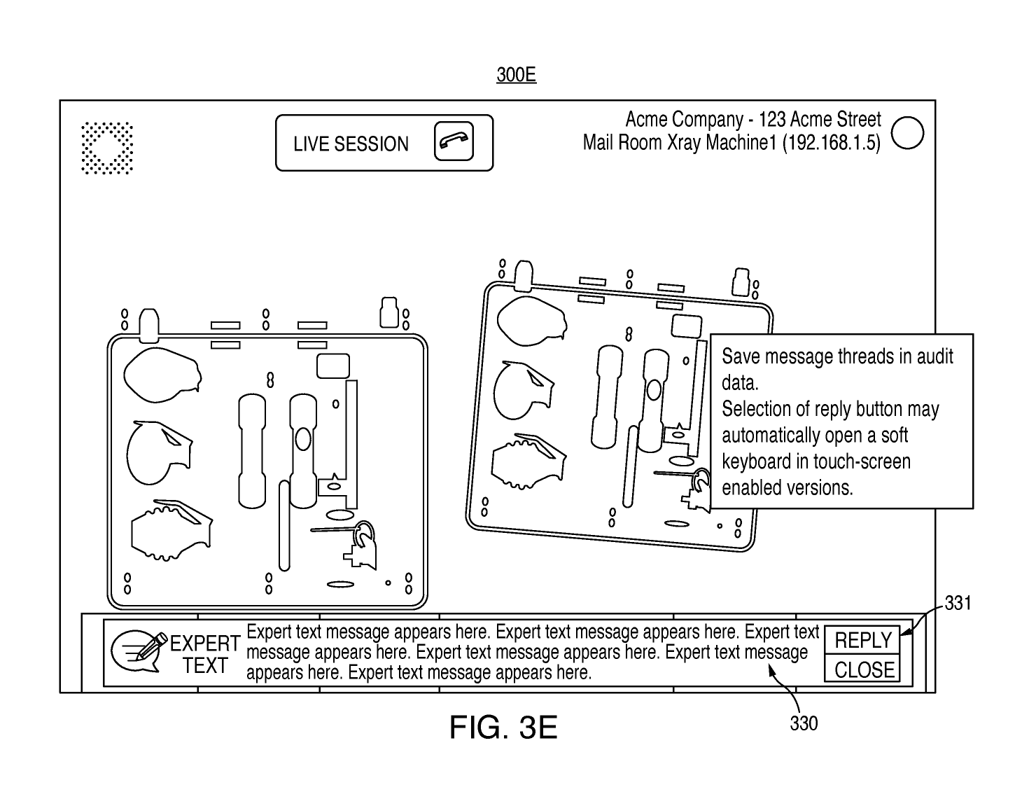

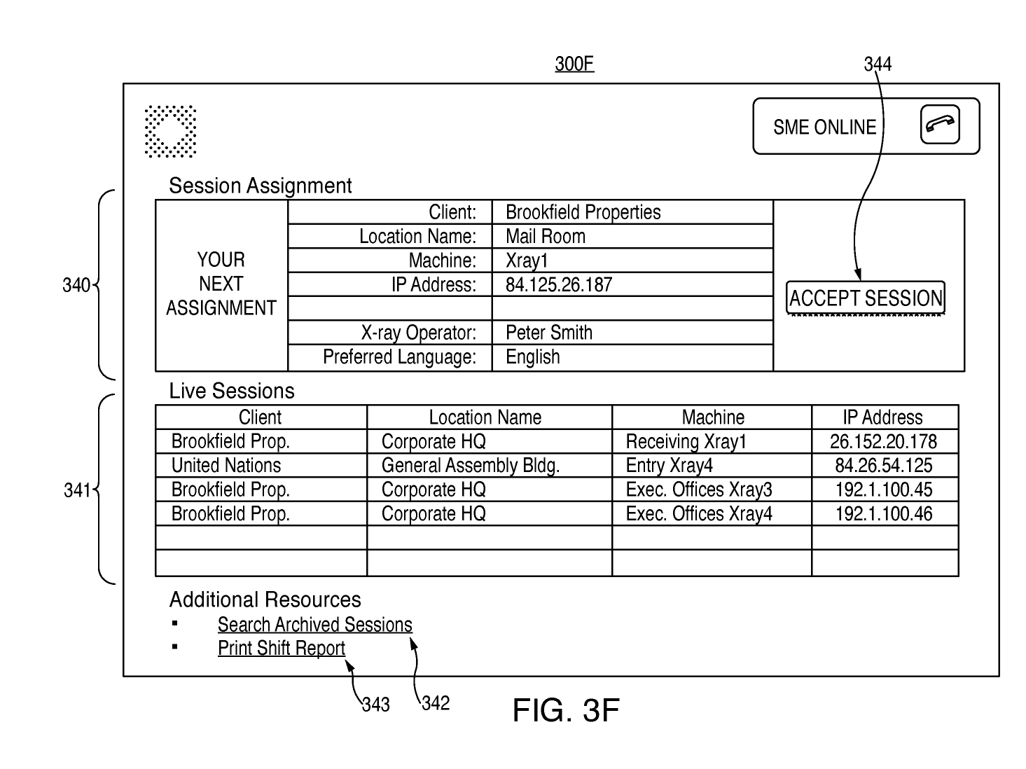

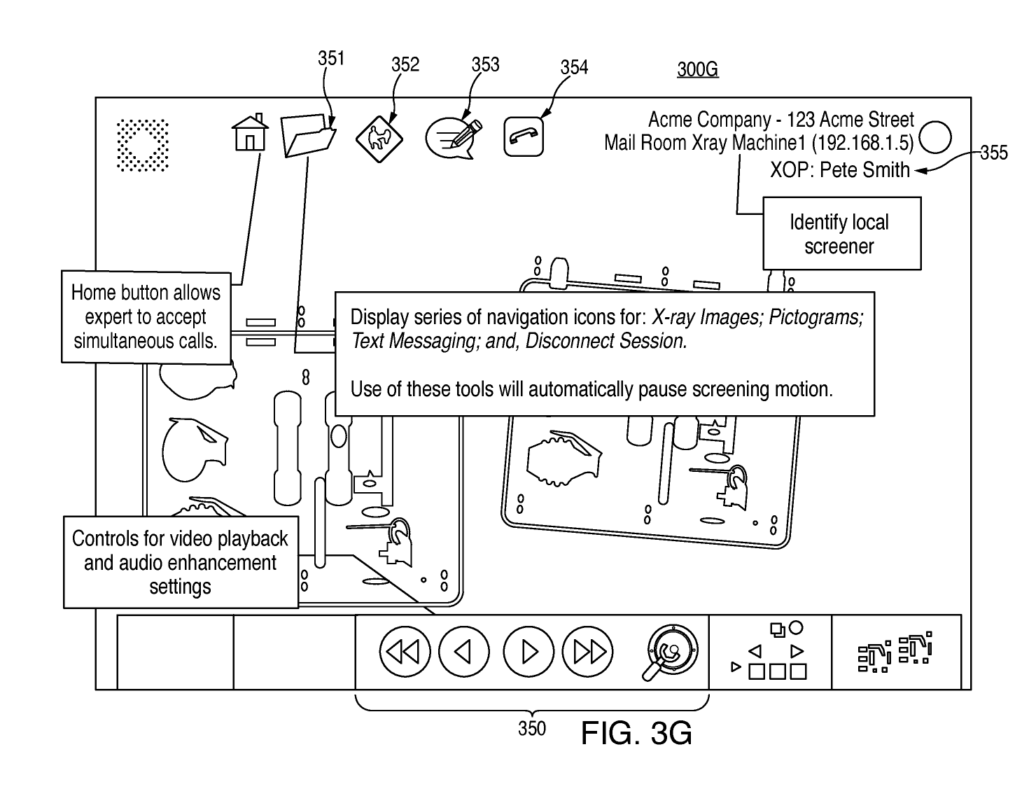

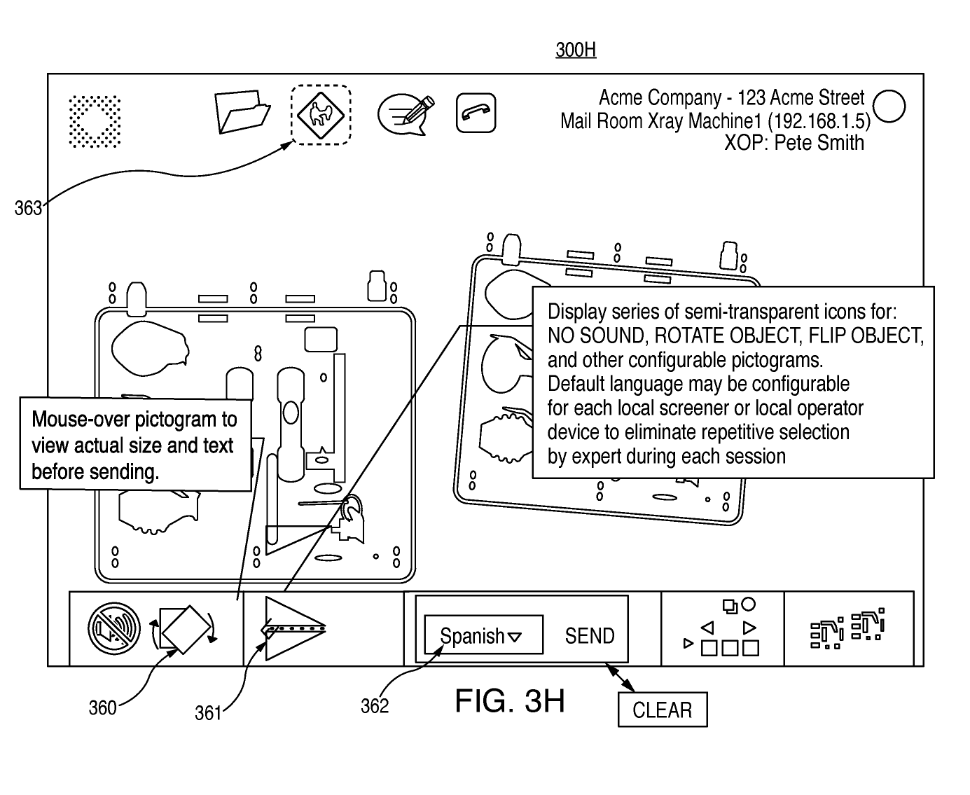

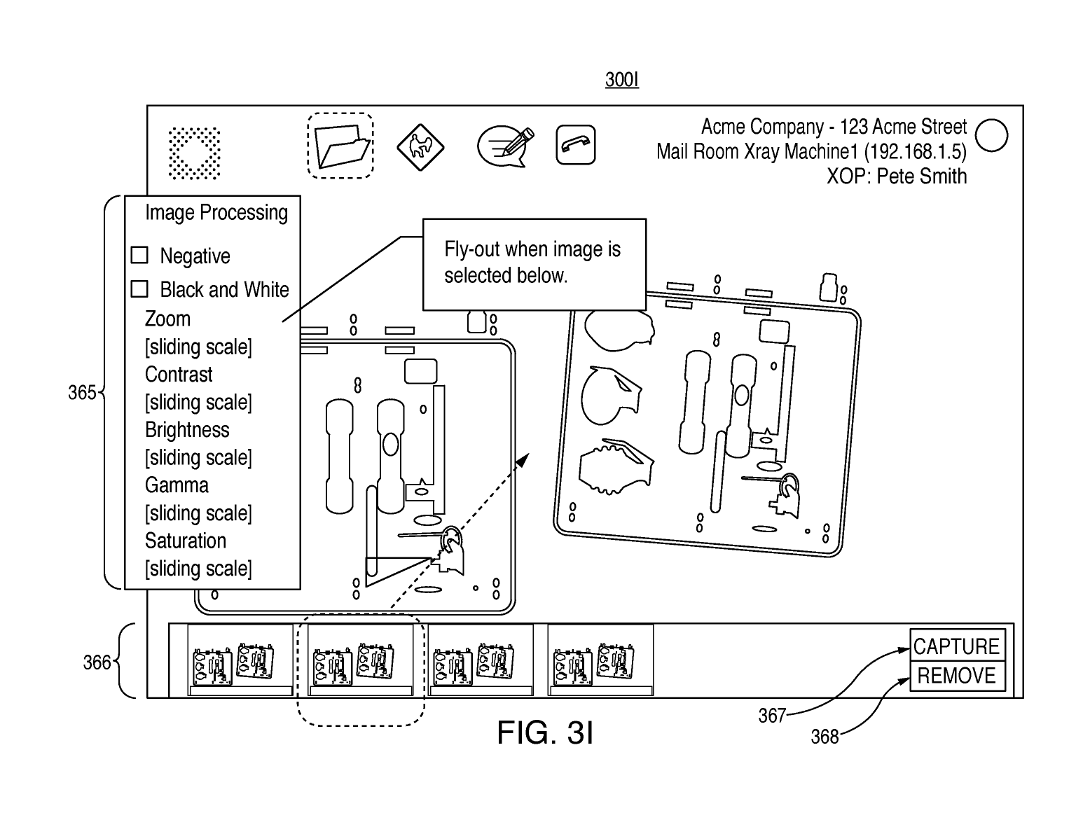

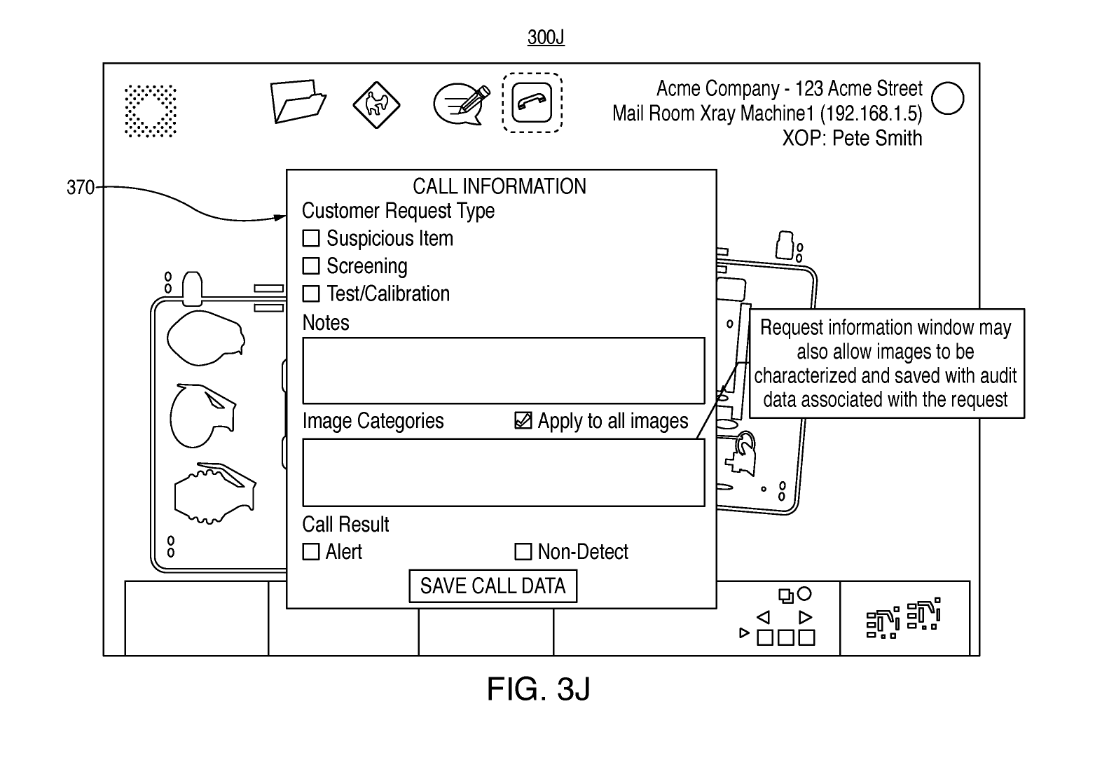

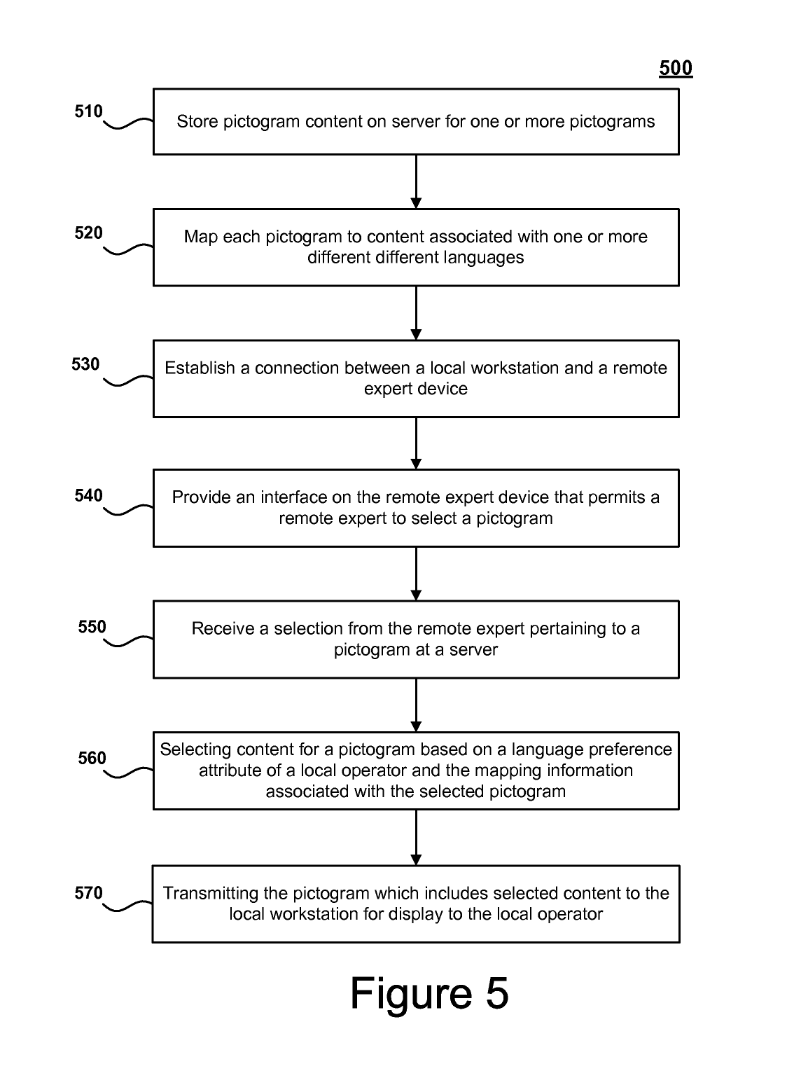

It should be noted that although the components on the memory 202 device may be described throughout this disclosure as software modules, such is not necessary. Any of the components may be implemented as software, hardware or a combination of the two. Furthermore, while the components may be illustrated as separate and distinct components, it should be recognized the components can be combined in a variety of different ways (e.g., all of the components may be executed as a part of a single program or as separately executing processes or threads) and that the functions performed by these components may overlap in some instances. In order to demonstrate the functionality performed by these components, reference will be made to FIGS. 3A-3J, which disclose exemplary interfaces that may be displayed on the local workstations 110 and remote expert devices 130, as well as FIGS. 4-5, which demonstrate exemplary methods that may be implemented by the server components, possibly in conjunction with other components of the system 100.

As explained above, there are many obstacles to providing an effective threat detection system in which experts are situated remotely from a screening device or screening location. First, the system should be able to minimize downtime as well as the delay associated with establishing a connection and evaluating a security threat. Second, the system should be able to allow local operators and remote experts to communicate and interact in real-time. Third, the system should be able to account for language barriers which may exist between local operators 101 and remote experts 131. Fourth, the system should provide redundant and unambiguous forms of communication to ensure that messages are accurately conveyed between parties. The connection module 250 and other components on the server 150 assist with overcoming these and other difficulties.

Several features may be incorporated into the connection module 250 in order to address the efficient routing and establishment of connections in a way that minimizes waiting and downtime. Initially, each of the local workstations 110 and remote expert devices 130 may register with the server 150 so that the server 150 can determine the devices which are connected to the system 100. For example, each device may register with the server 150 by submitting login credentials (e.g., username and password) or establishing a connection with the server 150.

FIG. 3A illustrates an exemplary interface 300A that may be displayed on a local workstation 110 as a local operator 101 registers with the server 150. An indicator is displayed in the upper right portion of the interface which specifies the status of the connection between the local workstation 110 and the server 150. For example, the indicator may specify that the local workstation 110 is disconnected from the server 150, establishing a connection with the server 150 or connected to the server. If the local workstation 110 is not connected to the server 150, then a local operator 101 may select a connection option 301 (e.g., link, button or other interface element) to connect to the server 150. A similar interface may be displayed on a remote expert device for registering with the server 150. After a local workstation or remote expert device registers with the server 150, the server 150 can determine that the device is connected to the system and can account for any attributes associated with the local workstation or remote expert device, as well as the attributes associated with the local operator or remote expert who is operating the device.

After the local workstation 110 has established a connection with server 150, a display may be presented to the local operator 101 which permits the local operator 101 to request assistance from a remote expert 131. For example, FIG. 3B illustrates an exemplary interface 300B which includes a threat assessment request option 305 and a testing and calibration request option 306. The local operator 101 may select the threat assessment request option 305 in order to request assistance from a remote expert 131 with respect to determining whether an item being inspected is a security threat. The local operator 101 may also select a testing and calibration request option 306 in order to ensure that a connection has been established with the server 150 and that the screening device 160 connected to the local workstation 110 is properly calibrated. In certain embodiments, a third diagnostics option may also be displayed on the interface for requesting diagnostic or troubleshooting assistance for either the local workstation 110 or the screening device 160. As mentioned above, the server 150 may give threat assessments a higher priority when it comes to routing the request to a remote expert 131. When a remote expert 131 accepts a request and establishes a session with the local operator 101, a live session indicator 307 may appear on the display.

In response to submitting a request, the connection module 250 will select a remote expert device 130 for receiving the request. Each remote expert device 130 may be assigned a status identifier that can be utilized by the server 150 to determine whether or not the remote expert device 130 has the ability to answer a request for assistance or is likely to answer a request for assistance. For example, in certain embodiments, each of the remote expert devices 130 may be assigned one of three statuses:

(1) Idle: This status indicates that a remote expert device 130 is not likely to answer a request for assistance due to inactivity. A remote expert 131 may explicitly indicate that the device is idle (e.g., by selecting a button presented on the interface which is displayed on the remote expert device 130). The server 150 may also designate a remote expert device 130 as idle if the remote expert device 130 does not respond to a request for assistance from a local operator 101. A remote expert device 130 which is designated as idle may become active when a remote expert 131 explicitly indicates that the device should be designated as active.
(2) Busy: This status indicates that a remote expert device 130 is currently assisting a local operator 101 with a request. Each time a connection is established between a local workstation 110 and a remote expert device 130, the server 150 may be notified that the remote expert device 130 should be designated as busy. After the request is handled, the server 150 may be notified that the remote expert device 130 is no longer busy and the server 150 may designate the remote expert device 130 as active.
(3) Active: This status indicates that a remote expert device 130 is available to assist a local operator 101 with a request.

Because the connection module 250 maintains a listing of all registered devices along with statuses of the registered remote expert devices 130, the connection module 250 is able to intelligently select a remote expert device 130 that has a high probability of responding to requests from local operators 101. In certain embodiments, for each remote expert device 130 that is designated as active, the connection module 250 determines when the last request was transmitted to, accepted, or concluded by the remote expert device 130. The connection module 250 may then select the remote expert device for which the longest period of time has elapsed since the device received a request, accepted a request or concluded a request. The server 150 may then forward the request to the remote expert device 130 that was selected.

If the remote expert 131 associated with the selected expert device 130 accepts the request, a connection is established between the local workstation 110 that sent the request and the selected remote expert device 130. However, if the remote expert 131 associated with the selected remote expert device 130 does not respond to the request, then the connection module 250 may designate the remote expert device 130 as being idle. The connection module 250 will then repeat the above-described process for selecting a remote expert device 130, thus resulting in the selection of the next registered remote expert device 130 that is designated as active and that has not received, accepted or concluded a request in the longest period of time. Configuring the server 150 to establish connections in this manner permits the server 150 to intelligently identify remote expert devices 130 that have a high probably of accepting requests for assistance, thus reducing downtime and waiting time when establishing a connection.

Attribute information 212 stored in a database 210 on the server 150 may be utilized by the connection module 250 to efficiently route a request and reduce the time delay associated with assessing a potential security threat. More specifically, the server 150 may store attribute information 212 that indicates traits, characteristics, and other information about the local operators 101, local workstations 110, remote experts 131, remote expert devices 130 and/or the screening devices 160. For example, attribute information 212 may be stored for each local operator 101 and each remote expert 131 which indicates the individual's name, level of experience and the language or languages which are spoken by the individual (or which are preferred by the individual). Attribute information 212 may also be stored for each local workstation 110 which indicates the location of the device (e.g., which identifies the screening location 120 and geographic location where the device is located), the version of the software installed on the device and the type of screening device 160 (e.g., manufacturer and model) that is being utilized by the local operator 101 or which is in communication with the local workstation 110. Attribute information 212 may also be stored for each remote expert device 130 that indicates the version of software installed on the devices, the location of the devices (e.g., whether the devices are located at the operations center 140 or other location). Other types of attribute information 212 may also be stored in the database 210 located on the server 150.

In addition to, or aside from, the status information discussed above, the connection module 250 may utilize the attribute information 212 to select the most appropriate remote expert device(s) 130 to which a request for assistance is routed. Specifically, the connection module 150 may analyze the attribute information 212 to determine the languages spoken by the local operator 101 and the remote expert 131, and to ensure that the local operator 101 and a selected remote expert 131 are able to speak the same language. For example, as part of the process of selecting a remote expert 131, the connection module 150 may only connect a local operator 101 with a remote expert 131 that speaks the same language or may give a higher priority to remote experts 131 that speak the same language as a local operator 101. As another example, the connection module 150 may only connect a local workstation 110 with a remote expert device 130 that is running the same version of software as the local workstation. As an even further example, the connection module 150 may only connect a local operator 101 with a remote expert 131 that is located within a particular distance of the local operator 101, or located within the same country or region as the local operator 101. The manner in which the connection module 150 may utilize the attribute information in establishing the connection may vary.

The language preferences included in the attribute information 212 may also be utilized to facilitate communications between a local operator 101 and remote expert 131 in the situation where a local operator 101 and remote expert 131 do not speak the same language. As mentioned above, the remote expert 131 and local operator 101 may utilize pictograms to communicate with each other. In that case that an operator 101 or expert 131 selects a pictogram to be transmitted to the other party, the server 150 may select the content of the pictogram 211 to ensure that the message associated with the pictogram will be conveyed to the intended recipient of the pictogram in a language which is understood by the recipient.

More specifically, a set of pictograms 211 may be provided to both local operators 101 and remote experts 131. As mentioned above, each pictogram may include text, icons, images and/or other multimedia data for conveying a particular message. Exemplary pictograms may convey messages relating for evaluating potential security threats, testing, troubleshooting and diagnostic issues. For example, a remote expert 131 may transmit a pictogram 211 to a local operator 101 that indicates whether or not an item is a security threat. In order to assist the remote expert 101 with analyzing an item, the remote expert 131 may also transmit pictograms that instruct the local operator 101 to rescan an item utilizing a screening device 160 or to rotate or flip an item that is being inspected. Similarly, other types of pictograms provided for testing, troubleshooting or diagnostic issues may convey messages indicating whether a local workstation 110 is properly connected to the system, whether a screening device is properly calibrated, or whether a particular communication feature (e.g., a voice, text or data connection) is functioning properly. Additional pictograms may also be provided for conveying other messages.

Each pictogram 211 may be associated with content for each of a plurality of languages (e.g., English, Spanish, French, Arabic, etc.). In the case that the local operator 101 and remote expert 131 do not speak the same language, one of the parties may select a pictogram 211 to transmit to the other party. Thereafter, the connection module 250 may receive the request to transmit the pictogram 211. The connection module 250 may then identify a language preference for the intended recipient of the pictogram 211 and select content for the pictogram 211 based on the language preference, thus ensuring that the message associated with the pictogram 211 will be conveyed in a language which is understood by the recipient.

FIG. 3D illustrates an exemplary interface 300D which may be displayed on a local workstation 110 that includes a pictogram 320 notifying the local operator 101 that the remote expert 131 is unable to hear the local operator 101. The pictogram 320 may include an icon of a disabled speaker and textual instructions for attempting to correct the issue. Similar pictograms may be transmitted by the remote expert 101 or local operator 101 to convey other messages as well.

The language preference of a local operator 101 or remote expert 131 who is receiving a pictogram 211 may be utilized by the connection module 250 to select the content of the pictogram 211 that is to be displayed the recipient. For example, consider a scenario in which a remote expert 131 speaks English and a local operator 101 speaks Spanish, and the remote expert 131 wishes to convey a message to the local operator 101 that notifies the local operator 101 that the remote expert 131 is unable to hear the local operator 101. In order to convey the message, the remote expert 131 may select a pictogram 211 for conveying this message (e.g., which may be similar to the pictogram 211 illustrated in FIG. 3D) from a list of available pictograms 211. The pictogram 211 may be displayed to the remote expert 131 in English if the language preference of the remote expert 131 is English (assuming the pictogram includes text and not just icons or graphics). In response to selecting a send button, the server 150 receives a request to transmit a pictogram 211 to the local operator 101 to inform the local operator 101 that the remote expert 131 is unable to hear the local operator 101. Before transmitting a pictogram to the local operator 101, the connection module 250 may determine the language of the local operator 101 (i.e., Spanish) by analyzing the attribute information 212 and select corresponding content for the pictogram that conveys the message in Spanish.

Thus, for each message that is the subject of a pictogram 211, the server 150 may store content for conveying the message in a plurality of different languages. A remote expert 131 or local operator 101 can simply select a message to be conveyed to the other party and the connection module 250 will automatically transmit a pictogram 211 having content that is able to convey the message in a language that is understood by the receiving party.

In certain embodiments, the party sending the pictogram can specify the language of the pictogram that will be displayed to a local operator 101 or remote expert 131 who is receiving a pictogram. However, the language preference of the receiving party may be utilized to select a default language for the pictogram.

FIG. 3H illustrates an exemplary interface 300H that may be displayed on a remote expert device 130 for transmitting a pictogram 211 to a local workstation 110. The interface may be displayed in response to selecting a pictogram option 363 from the menu displayed on the top of the interface. The bottom of the interface includes a toolbar that permits a user to select a pictogram 211, customize the content of a pictogram, specify the language of the receiving party and send the pictogram 211. A first selectable option 360 on the toolbar permits the user to view the pictogram that will be transmitted. A second selectable option 361 permits the user to customize the pictogram 211. For example, a user may customize the icons, text, colors or multimedia features included in a pictogram.

The toolbar also includes a language selection option 362 that permits the user to select a language. When the pictogram 211 is displayed to the receiving party, the pictogram 211 will be displayed in the selected language. In certain embodiments, the language preference data for the receiving party (which is stored in the attribute information 212) may be utilized to select a default language for the language selection option 362. The user transmitting the pictogram 211 may alter the default language if desired. After the user has selected and customized a pictogram 211, the user may select the send button to transmit the pictogram to the receiving party.

As can be seen, the language attributes stored in the attribute information 212 can be utilized to pair local operators 101 with remote experts 131 based on a common language or can also be utilized to facilitate communication between local operators 101 and remote experts 131 who do not speak the same language. Since communication between the local operator 101 and the remote expert 131 is crucial in resolving potential security threats, the use of the language attribute information by the connection module 250 can serve an important role with respect to overcoming language barriers that may be exist between parties and permitting potential security threats to be resolved quickly and efficiently.

In addition to the overcoming language barriers which may exist between local operators 101 and remote experts 131, the pictograms also serve an important role in the sense that the pictograms are able to convey an unambiguous message and provide a redundant means for communicating the message. While a remote expert 131 and local operator 101 may be permitted to communicate in other ways (e.g., voice or text), messages may be missed or misinterpreted for a variety reasons. For example, a lack of communication may exist due to technical failures (e.g., a bad connection or faulty equipment), personal disabilities or traits (e.g., one party does not speak clearly or has a hearing disability) or simply because one party was not paying close attention to the task at hand. However, the pictograms are able to convey a clear message utilizing both graphics and text. For example, even if the pictogram 320 in FIG. 3D was received by someone who did not speak English, the recipient of the pictogram 320 would immediately understand the message being conveyed by simply viewing the icon of the disabled speaker. The extra layer of clarity and redundancy provided by the pictograms can help to provide an expedited evaluation of potential security threats and a higher level of certainty that appropriate actions will be taken to handle potential security threats.

While the pictograms provide a very useful form of communication that can help to reinforce and clarify a particular message, the server 150 may permit a local operator 101 and remote expert 131 to communicate in other ways as well. In certain embodiments, a local operator 101 and remote expert 131 may communicate via a voice connections and/or a video conferencing connection. The parties may also communicate using a messaging feature such as an instant messenger.

FIG. 3E illustrates an exemplary interface 300E that may be displayed on a local workstation 110 in response to receiving a text message 330 from a remote expert 131. A local operator 331 may select a reply option 331 for responding to the text message 330. If the local workstation 110 is a touch screen device, selection of the reply option 331 may result in a soft keyboard (e.g., a virtual keyboard implemented in software) being displayed to the local operator 101. Remote experts 131 may receive and respond to messages in a similar manner. Either party may initiate the sending of a message 330 by selecting a messaging option 353 from a menu displayed on the local workstation 110 or the remote expert device 130. FIG. 3G, which is discussed in further detail below, illustrates an exemplary messaging option 353.

The attribute information 211 discussed above may be utilized by the server 150 in other useful ways as well. As one example, the attribute information 211 may be utilized to associate one or more remote experts 131 (or remote expert devices 130) with one or more screening locations 120 (or local workstations 110) for handling requests for assistance. For example, it may be preferred that a particular subset of remote experts 131 handle requests from a first screening location 120 (e.g., an airport) while a second subset of remote experts 131 handle requests from a second screening location 120 (e.g., a mailroom). Likewise, it may be preferred that a particular subset of remote experts 131 handle a first type of request for assistance (e.g., threat assessment requests), while another subset of remote experts 131 handle other types of requests (e.g., test requests and diagnostic requests). The reason for allocating a subset of remote experts 130 to a particular screening location 120 or to particular types of requests may be based on expertise with handling particular situations, languages spoken, geographic locations or for any other reason.

In order to allocate the remote experts 131 appropriately, the server 150 may store attribute information 212 which may be utilized by the connection module 250 to determine where a request from a particular workstation 110 or location 120 should be forwarded. Each time a request is received at the server 250, the server 250 may identify a subset of remote experts 131 that are associated with the particular workstation 110 or screening location 120 and then route the request to one of the remote experts 131 included in the subset (or give greater preference for routing the requests to the remote experts included in the subset).

The attribute information 212 may also be utilized to update software on a local workstation 110 or remote expert device 130. As mentioned above, the attribute information 212 may indicate the version of software which is running on the local workstation 130 and the remote expert devices 130. Thus, each time a local workstation 110 or remote expert device 130 connects to the server 150 or a request for assistance is transmitted to the server 150, the server 150 may determine whether the latest version of software is installed on the local workstation 110 or remote expert device 130. If it is determined that a local workstation 110 or remote expert device 130 does not have the latest version of software, the server 150 may push or otherwise provide the latest version of the software for installation on the local workstation 110. This can help to ensure compatibility between the software running on the local workstations 110 and remote expert devices 131.

In addition to storing attribute information 212 and pictograms 211, the database 210 illustrated in FIG. 2 also stores audit data 213. The audit data 213 includes various types of information associated with requests for assistance that are submitted by a local operator 101. For example, the audit data 213 may indicate the time that a request was submitted, the type of request that was submitted (e.g., threat assessment request, test request or diagnostic request), the amount of time it took to resolve the request, the local operator 101 who submitted the request, the local workstation 110 that submitted the request, the screening location 120 associated with the request, the remote expert 131 that handled the request, the remote expert device 130 that responded to the request, any remote experts 131 who received the request but who did not respond to the request, and the result of the expert's evaluation (e.g., true security threat or not a security threat). The audit data 213 may further include copies of scanning data (e.g., images or video) that was transferred from a local operator 101 to a remote expert 131, as well as any recordings or data associated with communications (e.g., via voice, text or pictograms) between the local operator 101 and the remote expert 131.

The audit data 213 may be useful for a variety of different purposes. For example, the audit data 213 may be utilized to train remote experts 131 or local operators 101. The audit data 213 may also be utilized to evaluate the performance of remote experts 131 or local operators 101. The audit data 213 may further be utilized to circulate alerts to screening locations 120 about items which pose security threats or items which appear to pose security threats, but which are not true security threats.

The audit data 213 may also be utilized by a reporting module 230 to generate a variety of different reports. The reports may be provided digitally or as a hard copy (e.g., paper copy). One type of exemplary report may be specific to each screening location 120. For example, the report may include statistics and other types of useful data related to activities that occurred at a screening location 120 during a particular time interval (e.g., over the course of a week, month or year). The report may indicate the number of items that were inspected at the screening location 120, the number of number of times requests were submitted to remote experts 131 for assistance (possibly sub-divided into categories for each type of request), the number of requests which resulted in the detection of a true security threat, the number of requests which were not deemed to be a true security threat, the average time it took to resolve a request, and any other data related to detecting threats at the screening location 120.

The report may also include detailed information for particular requests (e.g., requests that resulted in the detection of a true security threat). In certain embodiments, the report may also provide recommendations to a screening location 120. For example, the report may provide recommendations for increasing the number of security or screening personnel, training local operators 101, evaluating threats, reducing delays at checkpoints or other types of recommendations.

The reporting module 230 may also be utilized to generate a detailed report about a particular request that was received by a remote expert 131. The report may include any type of audit data 213 that was generated for the request. For example, it may identify the local operator 101 who submitted the request, the remote expert 131 that responded to the request, the expert's evaluation of the request, the type of request, etc. The report may further include images (e.g., actual photographs as well as X-ray images) of the items which were being evaluated and copies of any communications that took place between the local operator 101 and the remote expert 131.

In addition to the reports described above, it should be recognized that the reporting module 230 may generate other types of reports as well. For example, the reporting module 230 may generate reports which are specific to particular remote experts 131, local operators 101, screening devices 160, etc.

The exemplary server 150 illustrated in FIG. 2 also includes a set of admin controls 220. The admin controls 220 include functions which are accessible to the remote experts 131 and which permit the remote experts to perform a variety of different tasks including tasks for configuring and managing screening locations 120, specifying attribute information 210, transmitting alerts to workstations 110, and configuring remote expert devices 130. In certain embodiments, the functionality of the reporting module 230 may also be incorporated into the admin controls 220.

One feature of the admin controls 220 may include a set of customer controls for configuring and managing screening locations 120 and local workstations 110. The customer controls may permit a remote expert 131, system administrator, or other user associated with the threat detection system 100 to incorporate additional screening locations 120. For each screening location 120, the customer controls may further permit a user to set up new workstations 110 and screening devices 160 for use with the threat detection system 100, and to create new accounts or profiles for local operators 101. The customer controls may include graphical wizards that permit a non-technical user to easily navigate through a series of interfaces in order to incorporate new screening locations 120, workstations 110 and screening devices 160 into the system 100.

The customer controls may further permit a user to associate attribute information 212 with screening locations 120, workstations 110, screening devices 160 or local operators 101. For example, the admin controls 220 may permit the user to associate a language preference (or a particular set of pictograms) and time zone with a local operator 101, workstation 110 or screening location 120. The admin controls 220 can also be utilized to identify a particular subset of remote experts 131 to handle requests from a local operator 101, local workstation 110 or screening location 120.

The admin controls 220 may also include a set of expert device controls which are similar in some sense to the customer controls. For example, the expert device controls may allow a user to set up and add new remote expert devices 120 to the threat detection system, manage accounts or profiles for remote experts 131 and specify a preferred language for a remote expert 131, remote expert device 130 or operations center 140.

Another feature of the admin controls 220 permits a remote expert 131 or other user to create, edit or delete pictograms 211. For example, the remote expert 131 can incorporate icons, images, text, audio, video clips, animations and other content into a pictogram 211. Pictograms 211 can be created for any language. The admin controls 220 may permit the user to define the content of a pictogram 211 for a plurality of different languages and associate the different pieces of content with the pictogram 211.

In the case that content for a pictogram 211 is not available in a particular language, the admin controls 220 may permit the remote expert 131 to specify the content that will be associated with the language. For example, the remote expert 131 may specify that only icons or images should be displayed and that the text should not be displayed. Alternatively, the remote expert may specify that content associated with a different language should be utilized to populate the pictogram 211 that is displayed.

The admin controls 220 may also be configured to create, edit and delete alert messages. In some cases, the alert messages may provide information about actual security threats that were detected at particular screening locations 120. The alert messages may also provide information about potential security threats which may appear to present a security threat (e.g., which may appear to be an explosive, bomb or gun), but which were determined to be a non-threat or a false alarm. The alert messages may be transmitted to both local operators 101 and remote experts 131. In certain embodiments, a recipient of the alert message is able to acknowledge receipt of the message and the acknowledgment is recorded in the audit data 213 stored on the server 150.

FIG. 3C illustrates an exemplary interface 300C that may be displayed on a local workstation in response to receiving an alert message. As shown therein, an alert message 310 is displayed at the bottom of the interface. In certain embodiments, a user may select an option for viewing additional details about the alert (e.g., images and other information about items that are security threats). The user may select a clear option 311 to remove the alert message. In response to selecting the clear option 311, an acknowledgment may be recorded in the audit data 213 stored on the server 150 which indicates that the user has received the alert message. Similar alert messages may be displayed on remote expert devices 130.

The admin controls 220 may also provide a management interface that permits experts 131 or other users to view information relevant to prior and ongoing requests for assistance. For example, the management interface may display data or statistics associated with ongoing requests currently being handled, requests that were cleared (i.e., not determined to be a security threat), requests that were determined to be an actual security threat, average time to handle a request, total number of requests for a given time period (e.g., a day or week) and other types of similar information.

In certain embodiments, the management interface may also include links (e.g., hyperlinks) that can be selected by the user to view detailed information about a particular request. For example, in response to selecting a link that is associated with a particular request, the audit data 213 associated with the request may be retrieved from a database 210 on the server 150 in order to display the detailed information about the request to the user.

FIG. 3F illustrates an exemplary management interface 300F that may be displayed to a remote expert 131. The management interface includes a live session section 341 that displays information about all requests that are currently being handled by remote experts 131. For each ongoing request, the live session section 341 lists the name of the client or company that submitted the request, the particular screening location 120 at the company where the request originated from, the type of screening device 160 that is being utilized by the local operator 101 who submitted the request, and the internet protocol (IP) address of the local workstation 110 that submitted the request. In certain embodiments, one or more remote experts 131 may join an ongoing request by selecting the request in the live session section 341.

The management interface also includes a session assignment section 340 that permits a remote expert 131 to accept an unanswered request for assistance from a local operator 101. As explained above, the server 150 may select a remote expert 131 in response to receiving a request for assistance and invite the remote expert to accept the request. The selected remote expert 131 may accept the request by selecting the accept session option 344 located in the session assignment section 240 of the interface. Even before the remote expert 131 accepts the request, the remote expert 131 is able to identify the name of the client or company that submitted the request, the particular screening location 120 at the company where the request originated, the type of screening device 160, the internet protocol (IP) address of the local workstation 110 that submitted the request, the name of the local operator 101 that submitted the request and the preferred language of the local operator 101.

The management interface may also include an archived sessions option 342 that permits the remote expert to access prior requests that were handled along with any audit data 213 that is stored in the server database 210 for the requests. A shift report option 343 further permits the remote expert 131 to access the reporting module 230 and print various types of reports.

FIG. 3G illustrates an exemplary interface 300G that may be displayed on a remote workstation in response to accepting a request for assistance from a local operator 101 (e.g., in response to selecting the accept session option 344). The top portion of the interface includes a request details section 355 and a menu of selectable options. The request details section 355 displays the name and address of the company that submitted the request, the screening location 120 at the company where the request originated (e.g., in the case that a company has more than one screening location), the IP address of the local workstation 110 that submitted the request and the name of the local operator 101.

The menu on the interface includes a scanning data option 351 that permits a remote expert 130 to view X-ray images, videos or other types of scanning data that is generated by the screening device 160 being operated by the local operator 101. A pictogram option 352 permits a remote expert 131 to select and send a pictogram to the local operator 101 who submitted the request. A messaging option 353 permits the remote expert 131 to access an instant messaging function or similar feature that permits text messages to be exchanged with the local operator 101. A request termination option 354 permits the remote expert 131 to end a live session with the local operator 101. In certain embodiments, the menu may further include a home button option that permits the remote expert to return to a management interface (e.g., as shown in FIG. 3F). Returning to the management interface may permit the remote expert 131 to accept additional requests, thus permitting the remote expert 131 to simultaneously handle multiple requests.

In certain embodiments, the interface displayed to the remote expert 131 is a live audio/video feed that displays what is shown on the display of the local workstation 110. For example, as a local operator 101 manipulates images or other scanning data on the display of the local workstation 110, this can be viewed in real-time by the remote expert 131. A set of controls 350 permits the remote expert 131 to adjust video and audio settings associated with the audio/video feed. For example, the controls 350 may permit the remote expert to rewind, pause or fast forward through the feed. The controls 350 may further permit the remote expert 131 to adjust volume settings and other audio settings.

FIG. 3I illustrates an exemplary interface 300I that may be displayed in response to selecting the scanning data option 351 on the menu located at the top of the interface. As mentioned above, scanning data option 351 provides a remote expert 131 with access to X-ray images and other scanning data that may be generated by the screening devices 160. In this exemplary interface, a plurality of X-ray images are displayed in a thumbnail portion 366 of the interface. The remote expert 131 may select one of the images and the selected image will be displayed in the main portion of the interface.

In response to selecting the image, a set of image manipulation controls 365 may be displayed. The image manipulation controls 365 may permit the remote expert 131 to adjust a variety of different settings for the image. For example, the image manipulation controls 365 may permit the remote expert 131 to render the image in color, black and white or as a negative. The remote expert 131 may also zoom in and out on portions of the image and adjust the contrast, brightness, gamma and saturation values for the image. The image may be manipulated in other ways as well.

After the remote expert 131 has finished manipulating the image, the remote expert 131 may select a capture option 367 to generate a new image that includes the adjustments that were made using the image manipulation controls 365. A remove option 368 further permits the remote expert 131 to delete images in the thumbnail portion 366 of the interface. Any images which remain in the thumbnail portion 366 when the session has been terminated will be stored in the audit data 213 on the server 150 and associated with the request.

FIG. 3J illustrates an exemplary interface that may be displayed on a remote expert device 130 when terminating a session with a local operator 101. As explained above, a remote expert 131 may terminate a session by selecting a request termination option 354 from the menu located on the top portion of the interface. In response to selecting the request termination option 354, a request information window 370 may be displayed to the remote expert 131. The request information window 370 may include input elements for collecting information about the request. For example, the request information window 370 may permit the remote expert 131 to identify the request type (e.g., threat assessment, test/calibration, screening or diagnostics) and provide a description of the request. The remote expert 131 may also categorize the images or other scanning data 160 that were reviewed during the request.

The request information window 370 may further include a section which permits the remote expert 131 to specify the evaluation or conclusion that was reached by the remote expert 131. Thus, in the context of a threat assessment request, this may include indicating whether or not the request resulted in the detection of an actual security threat. On the other hand, if the request is for a diagnostics problem, this may including indicating whether or not the problem was solved. Similarly, in the context of a test or calibration request, this may include indicating whether or not the test or calibration was successful.

FIG. 4 is a flow chart illustrating a method 400 for establishing a connection between a local workstation 110 and a remote expert device 130 in accordance with certain embodiments of the present invention. In certain embodiments, the method 400 may be executed by the connection module 250 on the server 150, possibly in conjunction with other components of the threat detection system 100. Initially, attribute information 212 associated with one or more local operators 101 and one or more local workstations 110 may be stored on a server 150 (step 410). For example, attributes 212 may be stored for each local operator 101 that indicate the individual's name, experience level and language preference, as well as for each local workstation 110 that indicate the screening location of the workstation, the IP address of the device, a company associated with the screening location of the workstation 110, the version of the software installed on the workstation and the type of screening device 160 that is connected to the local workstation 110. In certain embodiments, this step may further involve storing attribute information 212 on the server 150 for remote experts 131, remote expert devices 130, screening devices 160 and/or other components of the threat detection system.

In certain embodiments, the admin controls 220 may be utilized by a remote expert 131 or other user in order to integrate new or additional local workstations 110, local operators 101, screening locations 120, screening devices 160, remote expert devices 130 and/or remote experts 131 into the threat detection system. Thus, the attribute information 212 may be stored on the server 150 each time a new component or individual is integrated into the system. The attribute information 212 may be stored on the server 150 in other ways as well.

Next, the local workstations 110 and the remote expert devices 130 may register with the server 150 (step 420). For example, each time a local workstation 110 or remote expert device 130 is being utilized, a local operator 101 or remote expert 131 may enter authentication credentials (e.g., a username and password) and the local workstation 110 or remote expert device 130 may register with the server 150. This permits the server 150 to determine all of the local workstations 110 and remote expert devices 130 that are currently being utilized by the threat detection system, as well as the identity of the individuals who are operating the devices.

A request submitted by a local operator 101 is then received at the server 150 which includes a unique identifier (step 430). As explained above, the request may relate to a threat assessment request, a test request or a diagnostics request. Other types of requests may be transmitted as well. A local operator 101 may submit a request by selecting an option (e.g., threat assessment request option 305) on an interface that is displayed on a local workstation 110. The server 150 utilizes the unique identifier submitted with the request to identify the local operator 101 and local workstation 110 that submitted the request, as well to identify the stored attribute information 212 for the local operator 101 and local workstation 110 (step 440).

A session is then establishing between the identified local workstation 110 and the server 150 (step 450). In certain embodiments, establishing a session may involve transmitting a token to the identified local workstation 110 and establishing the session when the local workstation 110 transmits the token back to the server 150.

Next, the server 150 identifies a remote expert device 130 to receive the request (step 460). In certain embodiments, the server 150 may select the remote expert device 130 by executing the sub-process shown in step 460. Specifically, the server 150 may identify all registered remote expert devices (step 461) and determine which of the registered expert devices 130 are designated as active (step 462). The server 150 may then identify the active expert device 130 that is queued to receive the next request (step 463). In certain embodiments, the expert device 130 that is next in the queue is the expert device 130 that is designated as active and for which the longest period of time has elapsed since the device received a request, accepted a request or concluded a request.

As an optional sub-step which is not shown in FIG. 4, the server 150 may utilize the language preference attributes of the local operator 101 who submitted the request and the remote experts 131 who are registered with the system to filter the list of active remote expert devices 130 or to adjust a weighting factor for selecting the remote expert device 130. For example, in some cases, the server 150 may not forward the request to a remote expert device 130 if the attribute information 212 for a remote expert 131 indicates that the remote expert 131 does not speak the same language as the local operator 101 who transmitted the request. In other cases, the language preference information may not exclude a remote expert device 130 from being selected altogether, but the language preference information may be considered as a factor in the selection process.

After the server 150 forwards the request to the selected remote expert device 130, a determination is made as to whether the selected remote expert device 130 accepted the request (step 470). If the selected remote expert device 130 did not accept the request, the server 150 changes the status of the remote expert device 130 from active to idle (step 480), and the method proceeds back to step 460 where the server 150 identifies another remote expert device 130 for receiving the request in the same manner described above. The server 150 may continue to loop in this manner until the request is accepted by a remote expert device 130.

If a selected remote expert device 130 accepts the request, the server 150 establishes a connection between the local workstation 110 that submitted the request and the selected remote expert device 130 (step 480). In certain embodiments, the connection may permit voice, text, data and/or video communication. The communication channels provided by the connection may permit the local operator 101 to communicate with the remote expert 131 to resolve the request.

FIG. 5 is a flow chart of a method 500 for transmitting a pictogram 211 to a local workstation 110 in accordance with certain embodiments of the present invention. In certain embodiments, the method 500 in FIG. 5 may be performed by the server 150, possibly in conjunction with other components of the threat detection system 100.

Initially, pictogram content associated with one or more pictograms 211 is stored on a server 150 (step 510). As explained above, each pictogram 211 may be associated with a particular message that the pictogram 211 is intended to convey to its recipient. Exemplary messages that may be conveyed by a pictogram 211 include messages related to assessing a security threat (e.g., which indicate whether or not the item poses a threat), technical issues (e.g., which indicate that an audio, data or other type of connection is not working), testing issues (e.g., which confirm or deny the connectivity of a local workstation) or diagnostic issues (e.g., which indicate that a screening device 160 is not properly working). In order to convey the message associated with the pictogram 211, each pictogram may include text, icons, images, animations, videos and/or other content. For example, the content of some pictograms 211 may include an icon and text for conveying the message, while other pictograms 211 may simply include an icon for conveying the message.

Each pictogram 211 may be mapped to content associated with one or more different languages (step 520). Thus, while each pictogram 211 may be associated with a particular message, the content of the pictogram can be varied by mapping the pictogram to content for a plurality of different languages. In order to accomplish this, content may be defined for each of a plurality of different languages and the content for each language may be associated with the pictogram. For example, a single pictogram 211 may be mapped to several different groupings of content for conveying the message associated with the pictogram 211 in English, Spanish, French, Arabic, etc.

Next, the server 150 may establish a connection between a local workstation 110 and a remote expert device 130 (step 530). In certain embodiments, this may be performed utilizing the method 400 illustrated in FIG. 4. Upon establishing the connection, an interface may be displayed on the remote expert device 130 that permits a remote expert 131 who is operating the remote expert device 130 to select a pictogram 211 (step 540). FIG. 3H demonstrates an exemplary interface that permits a remote expert to select a pictogram 211. In certain embodiments, the interface may also permit the remote expert 131 to customize the content of the pictogram. After a remote expert selects a pictogram 211, the server 150 receives the selection from the remote expert 130 (step 550).

Upon receiving the selection from the remote expert 130, the server 150 selects content for the pictogram 211 based on a language preference attribute of the local operator 101 and the mapping information associated with the selected pictogram 211 (step 560). Specifically, the server 150 may analyze the attribute information 212 stored on the server 150 to determine a language preference for the local operator 101 who is the intended recipient of the message. The server 150 may then utilize the mapping information to identify content for the pictogram 211 that has been mapped to the language indicated by the language preference. Thus, if the language preference for the local operator 101 is Spanish, the server 150 may utilize the mapping information to select content for the pictogram that is associated with Spanish speakers. The pictogram 211 including the selected content is then transmitted to the local operator 110 for display to the local operator 101 (step 570).

It should be recognized that the exemplary method 500 illustrated in FIG. 5 can be varied in numerous ways. While FIG. 5 demonstrates how a remote expert 131 can transmit a pictogram to a local operator 101, it should be evident that a remote operator 101 can transmit pictograms 211 to a remote expert 131 using the same principles. For example, the local operator 101 may be provided with an interface that permits the local operator 101 to select a pictogram for transmission to the remote expert 131, and the server 150 may utilize the language preference of the remote expert 131 to select the content of the pictogram 211.

Moreover, in certain embodiments, the language preference associated with an intended recipient of the message may be utilized in other ways. For example, the interfaces for selecting pictograms may include a language selection option 362 (e.g., as illustrated in FIG. 3H) that permits the sender of a pictogram 211 to specify the language in which the pictogram 211 will be displayed to the recipient and the language preference associated with the recipient may be utilized to pre-select a default value for the language selection option 362. However, the sender of the pictogram 211 may adjust the pre-selected language preference if desired. Upon receiving the pictogram 211 selected by the sender, the server 150 will select the content of the pictogram 211 based on the language identified by the language selection option 362.

In addition, it should be noted that in some cases, the same content may be mapped to more than one language. For example, in the case that a pictogram 211 only includes an icon, the icon may effectively convey the message associated with the pictogram 211 to a recipient regardless of the language spoken by the recipient. Thus, the same content may be mapped to all languages for that particular pictogram 211. Similarly, in the case that a recipient speaks a rare language, pictogram content may not be available for conveying a message in the language. A default set of content may be utilized to populate a pictogram in such cases.

While there have shown and described and pointed out various novel features of the invention as applied to particular embodiments thereof, it will be understood that various omissions and substitutions and changes in the form and details of the systems and methods described and illustrated, may be made by those skilled in the art without departing from the spirit of the invention. Amongst other things, the steps shown in the methods may be carried out in different orders in many cases where such may be appropriate. Those skilled in the art will recognize, based on the above disclosure and an understanding therefrom of the teachings of the invention, that the particular hardware and devices that are part of the system described herein, and the general functionality provided by and incorporated therein, may vary in different embodiments of the invention. Accordingly, the particular system components shown in the figures are for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation.

What is claimed is:

1. A system for detecting security threats in a network environment, comprising:
a local workstation that is configured to:
render scanning data generated by a screening device associated with an item being inspected; and
submit a request for assistance to determine whether the item raises a security threat;
a remote expert device that is configured to:
accept the request for assistance submitted by the local workstation; and
receive attribute information associated with the local workstation and an individual operating the local workstation; and
utilize the attribute information to communicate with the local workstation for determining whether the item relates to a security threat; and
a server that is configured to:
store the attribute information associated with the local workstation and the individual operating the local workstation, wherein the attribute information is utilized to facilitate communications between the local workstation and the remote expert device in response to the local workstation submitting the request;
receive the request for assistance from the local workstation over a network;
determine that the remote expert device is designated as active;
route the request to the remote expert device; and
in response to the request being accepted by the remote expert device, transmit the attribute information to the remote expert device and establish a connection between the local workstation and the remote expert device.

2. The system of claim 1, wherein the attribute information includes language preference information that indicates a preferred language for displaying communications on the local workstation.

3. The system of claim 2, wherein the server is further configured to receive a selection to transmit a pictogram to the local workstation, and the language preference information is utilized to select content for the pictogram.

4. The system of claim 2, wherein the remote expert device is further configured to:
display an interface for selecting a pictogram; and
utilize the language preference information to select a default language to be associated with the content of the pictogram.

5. The system of claim 1, wherein the system comprises a plurality of remote expert devices and the server is configured to select the remote expert device to receive the request based on when a request was last received, accepted or concluded by the remote expert device.

6. The system of claim 1, wherein the server is further configured to store audit data associated with the request that was submitted by the local workstation, the stored audit data including information that at least identifies:
the local workstation that submitted the request;
the individual operating the local workstation;
the remote expert device;
a remote expert associated with the remote expert device;
the scanning data generated by the screening device; and
the remote expert's assessment of the security threat.

7. The system of claim 1, wherein the local workstation is further configured to submit a request for testing connectivity or calibrating the local workstation.

8. The system of claim 1, wherein the local workstation is further configured to submit a request for diagnostic assistance.

9. The system of claim 1, wherein the server is configured to designate the remote expert device as idle if the request is not accepted by the remote expert device.

10. A server for detecting security threats in a network environment, wherein the server is configured to:
maintain a list of local workstations and remote expert devices that are registered with a threat detection system;
store attribute information associated with the local workstations and individuals operating the local workstations, wherein the attribute information is utilized to facilitate communications between the local workstations and the remote expert devices in the list;
receive a request over a network from a first local workstation for assistance in determining whether an item presents a security threat;
in response to receiving the request, identify the remote expert devices in the list that are designated as active;
select one or more of the identified remote expert devices that are designated as active to receive the request from the first local workstation;
route the request to the one or more selected remote expert devices; and
in response to the request being accepted by the one or more selected remote expert devices, transmit the attribute information associated with the first local workstation to the one or more selected remote expert devices and establish a connection between the first local workstation and the one or more selected remote expert devices.

11. The server of claim 10, wherein the attribute information includes language preference information for each local workstation that indicates a preferred language for displaying communications on each of the local workstations.

12. The server of claim 11, wherein the server is further configured to receive a selection to transmit a pictogram to the first local workstation, and the language preference information is utilized to select content for the pictogram.

13. The server of claim 11, wherein the remote expert devices are configured to:
display an interface for selecting a pictogram; and
utilize the language preference information to select a default language to be associated with the content of the pictogram.

14. The server of claim 10, wherein the server selects one or more of the identified remote expert devices that are designated as active to receive the request based on when a request was last received, accepted or concluded by the remote expert devices.

15. The server of claim 10, wherein the server is further configured to store audit data associated with the request that was submitted by the first local workstation, the stored audit data including information that at least identifies:
the first local workstation that submitted the request;
the individual operating the first local workstation;
the remote expert device;
a remote expert associated with the remote expert device;
the scanning data generated by the screening device; and
the remote expert's assessment of the security threat.

16. The server of claim 10, wherein the local workstations are configured to submit a request for testing connectivity or calibrating the local workstation.

17. The server of claim 10, wherein the local workstations are further configured to submit a request for diagnostic assistance.

18. The server of claim 10, wherein the server is configured to designate the one or more selected remote expert devices as idle if the request is not accepted by the one or more selected remote expert devices.
